(19) United States
(12) Patent Application Publication
(10) Pub. No.: US 2002/0084967 A1
(43) Pub. Date: Jul. 4, 2002

(54) Image display apparatus and driving method thereof

(76) Inventors: Hajime Akimoto, Oume (JP); Minoru Hoshino, Hitachi (JP); Yoshiro Mikami, Hitachiota (JP); Shinichi Komura, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/809,002

(22) Filed: Mar. 16, 2001

(30) Foreign Application Priority Data
Jan. 4, 2001 (JP) 2001-48

(51) Int. Cl. G09G 3/36

(52) U.S. Cl. 345/90

(57) ABSTRACT

To provide an image display apparatus satisfying the reduction of the electric power consumption and the downsizing of the cost simultaneously.

An image display apparatus has a display part composed of plural pixels; a control part for controlling the display part; and a signal line arranged inside the display part for inputting a display signal into said pixel, wherein the pixel has at least one or more switches and first capacitances for storing the display signal input through the signal line as charge for a designated period of time or longer; and further has a means for rewriting the display signal stored in the first capacitance into the first capacitance without using the signal line in responsive to an instruction of the control part.

### BACKGROUND OF THE INVENTION

The present invention relates to an image display apparatus enabling an image display with lower electric power consumption.

Now, referring to FIGS. 29 and 30, two prior arts are described.

FIG. 29 shows a configuration of the TFT liquid crystal display panel using a prior art. The pixels 210 each having liquid crystal capacitance 209 are arranged in a matrix configuration at the display part (only a single pixel 210 is illustrated in FIG. 29 for simplifying the drawing), and the pixel 210 is connected through the gate line 211 and the AC drive signal line 207 to the gate line drive circuit 215, and connected through the positive signal line 212 and the negative signal line 213 to the signal line drive circuit 214. The pixel 210 has SRAM (Static Random Access Memory) composed of the inverter 203 and the inverter 204, and its two data input and output notes are connected through the data input switches 210 and 202 to the positive signal line 212 and the negative signal line 213, respectively. Those data nodes are also connected to the liquid crystal capacitance write switches 205 and 206. The liquid crystal capacitance is connected through the liquid crystal capacitance write switches 205 and 206 to the AC drive signal line 207 and the resent voltage line 208.

Now, the operation in this prior art is described. As the gate line drive circuit 215 opens and closes the data input switches 201 and 202 for the designated pixel line through the gate line 211, the 1-bit complementary image data on the positive signal line 212 and the negative signal line 213 supplied by the signal drive circuit 214 are put into SRAM composed of the inverter 203 and the inverter 204 in the pixel 210. As long as the electric power is applied, SRAM holds statically the 1-bit image data as supplied in the above manner. Either of the liquid crystal capacitance write switches 205 and 206 is turned on by the image data written in SRAM, and then, the voltage selected exclusively from either of the AC drive signal line 207 or the resent voltage line 208 is applied to the liquid crystal capacitance 209. Thus, if the AC drive signal line 207 is selected, AC voltage is applied to the liquid crystal capacitance 209, and if the resent voltage line 208 is selected, any voltage is not applied to the liquid crystal capacitance 209. Owing to this operation, this liquid crystal display panel can continue to display the 1-bit display image even if the scan of the gate line 211 by the gate line drive circuit 215 and the data out to the positive signal line 212 to the negative signal line 213 by the signal line drive circuit 214 are made suspended.

The prior art as described above is described in detail in Japanese Patent Application Laid-Open No. 8-286170 (1996).

Next, by referring to FIG. 30, another prior art is described.

FIG. 30 shows a configuration of the TFT liquid crystal display panel using a prior art. The pixels 230 each having liquid crystal capacitance 209 are arranged in a matrix configuration between the pixel electrodes 224 and the opposed electrodes 225 at the display part (only a single pixel 230 is illustrated in FIG. 30 for simplifying the drawing), and the pixel 230 is connected through the gate line 231 to the gate line drive circuit 235, and connected through the signal line 232 to the signal line drive circuit 234. The pixel 230 has DRAM (Dynamic Random Access Memory) composed of the data input switch 221 and the hold capacitance 222, and the terminal of its data input switch 221 is connected to the signal line 232. The data node of DRAM is connected to the gate of the pixel drive switch 223, and the liquid crystal capacitance is connected through the pixel drive switch 223 to the common electrode line 233. The common electrode line 233 is connected to the common electrode drive circuit 237, and the opposed electrode 225 is connected to the opposed electrode drive circuit 236.

Now, the operation in this prior art is described. As the gate line drive circuit 235 opens and closes the data input switch 221 for the designated pixel line through the gate line 231, the 1-bit image data on the signal line 232 supplied by the signal line drive circuit 234 are put into DRAM composed of the data input switch 221 and the hold capacitance 222. In responsive to the image data written into DRAM, the pixel drive switch 223 is locked so as to hold an on state or an off state. As AC voltage is applied to the opposed electrode by the opposed electrode drive circuit 236 and a designated voltage is applied to the common electrode line 233 by the common electrode drive circuit 237, if the pixel drive switch 223 is turned on, AC voltage is applied to the liquid crystal capacitance between the pixel electrode 224 and the opposed electrode 225, and in contrast, if the pixel drive switch 223 is turned off, any voltage is not applied to the liquid crystal capacitance. Owing to this operation, the liquid crystal display panel can continue to display the 1-bit display image until the data on DRAM is lost by the leak current, even if the scan of the gate line 231 by the gate line drive circuit 235 and the data output onto the signal line 232 by the signal line drive circuit 234 are made suspended. In order to hold the display image data statically, it is only required to rewrite DRAM periodically by scanning the gate line 231 with the gate line drive circuit 235 and putting out the data onto the signal line with the signal line drive circuit 234.

The prior art as described above is described in detail in Japanese Patent Application Laid-Open Number 9-258168 (1997).

According to the prior arts as described above, it will be appreciated that the scan of the gate line and the data output onto the signal line may be suspended or the number of those operations can be reduced, which leads to the reduction in the electric power consumption for TFT liquid crystal display panels.

According to the prior arts described above, it is difficult to achieve simultaneously the reduction in the electric power consumption and the downsizing in the cost.

In the first prior art in which SRAM is installed inside the pixel, there is such an advantageous aspect as the operations for scanning the gate line and for data output to the signal line can be completely suspended and the electric power consumption can be reduced, but in contrast, there is such an disadvantageous aspect as the pixel structure becomes inevitably sophisticated as the number of transistors formed in SRAM is larger. As the throughput of manufactured devices inevitably for the sophisticated pixel structure, the price of the image display apparatus may increase.

In the second prior art in which DRAM is installed inside the pixel, there is such an advantageous aspect as the pixel structure can be simplified as the number of transistors formed in DRAM and the downsizing in the price of the image display apparatus may be expected due to the increase in the throughput of the manufactured devices. However, as DRAM requires principally rewrite (refresh) operations, the operations for scanning the gate line by the gate line drive circuit 235 and for data out onto the signal line by the signal line drive circuit 234 can not completely suspended. As for the data output onto the signal line, as it is required to supply the data onto the signal line having relatively larger parasitic capacitance as many times as equivalent to the number of pixels for writing the overall display part, there still remains such a problem as further reduction in the electric power consumption can not achieved easily. In addition, as it is required to reserve the display image data to be used for the rewrite operation at any other part, additional electric power consumption and cost may be inevitable.

And furthermore, though the prior arts described above assumes that the 1-bit display image data are used for the individual pixel, it is expected to establish the handling of multi-bit display image data as well as achieving the reduction in the electric power consumption and the downsizing in the cost of the manufactured device.

### SUMMARY OF THE INVENTION

According to the embodiment of the present invention, the problem stated as the establishment of the reduction in the electric power consumption and the downsizing in the cost of the manufactured devices can be solved by providing an image display apparatus comprising a display part composed of plural pixels; a control part for controlling the display part; and a signal line arranged inside the display part for inputting a display signal into the pixel, in which the pixel has at least one or more switches and first capacitances for storing the display signal input through the signal line as charge for a designated period of time or longer; and further comprising a means for rewriting the display signal stored in the first capacitance into the first capacitance without using the signal line in responsive to an instruction of the control part.

In addition to the above problem, the problem stated as the establishment of displaying a multi-bit display data can be solved by forming plural (n+1) or more capacitances inside the individual pixel for storing an n-bit display signal as charge for a designated period of time.

It will be appreciated that further downsizing in the cost of the manufactured devices can be established by simplifying more the pixel structure by forming a charge transfer device (CTD) in the individual pixel.

The problem stated as the establishment of the reduction in the electric power consumption and the downsizing in the cost of the manufactured devices can be solved by providing an image display apparatus comprising a display part composed of plural pixels; a display signal processing part for storing a display signal supplied from outside and performing data processing for the display signal; a control part for controlling the display part and the display signal processing part; and a signal line arranged inside the display part for inputting a display signal into the pixel, in which the pixel has at least one or more switches and first capacitances for storing the display signal input through the signal line as charge for a designated period of time; and further comprising a means for rewriting the display signal stored ins the first capacitance into the first capacitance without using the signal line in responsive to an instruction of the control part.

The problem stated as the establishment of the reduction in the electric power consumption and the downsizing in the cost of the manufactured devices can be solved by providing an image display apparatus comprising a display part composed of plural pixels; a control part for controlling the display part; and a signal line arranged inside the display part for inputting a display signal into the pixel, in which the pixel has at least one or more switches and first capacitances for storing the display signal input through the signal line as charge for a designated period of time or longer; and further comprising a drive method for rewriting the display signal stored in the first capacitance into the first capacitance without using the signal line in responsive to an instruction of the control part.

A drive method of an image display apparatus comprising a display part composed of plural pixels; a display signal processing part for storing a display signal supplied from outside and performing data processing for the display signal; a control part for controlling the display part and the display signal processing part; and a signal line arranged inside the display part for inputting a display signal into the pixel; in which the pixel has at least one or more switches and first capacitances for storing the display signal input through the signal line as charge for a designated period of time, and the method comprises a first mode for rewriting the display signal stored in the first capacitance into the first capacitance without using the signal line in responsive to an instruction of the control part; and a second mode for writing a display signal having analog voltage or multi-valued voltage levels is performed by interrupting the rewrite operation for the first capacitance in the pixel and using a signal line to the first capacitance in stead, in which an electric power consumption of a display signal processing part in the first mode is made smaller than an electric power consumption of a display signal processing part in the second mode.

### BRIEF DESCRIPTION OF THE DRAWINGS

FIG. 1 is a block diagram of Poly Si-TFT liquid crystal display panel as the embodiment 1.

FIG. 2 is an internal block diagram of the pixel in the embodiment 1.

FIG. 3 is a view showing drive signal waveforms when writing 1-bit pixel data in the embodiment 1.

FIG. 4 is a view showing drive signal waveforms when writing 3-bit pixel data in the embodiment 1.

FIG. 5 is a potential diagram when writing 1-bit pixel data in the embodiment 1.

FIG. 6 is a potential diagram when writing 2-bit pixel data in the embodiment 1.

FIG. 7 is a drive signal waveforms when displaying and rewriting image data in the embodiment 1.

FIG. 8 is a potential diagram when displaying and rewriting image data in the embodiment 1.

FIG. 9 is a display sequence chart of 3-bit image data in the embodiment 1.

FIG. 10 is a cross-sectional view of a part of the pixel in the embodiment 1.

FIG. 11 is an internal view of the pixel in the embodiment.

FIG. 12 is a view showing drive signal waveforms when writing 1-bit pixel data in the embodiment 2.

FIG. 13 is a view showing drive signal waveforms when writing 3-bit pixel data in the embodiment 2.

FIG. 14 is a potential diagram when writing 1-bit pixel data in the embodiment 2.

FIG. 15 is a potential diagram when writing remaining 2-bit image data in the embodiment 2.

FIG. 16 is a view showing drive signal waveforms when displaying and rewriting image data in the embodiment 2.

FIG. 17 is a potential diagram when displaying and rewriting image data in the embodiment 2.

FIG. 18 is an internal diagram of the pixel in the embodiment 3.

FIG. 19 is a view showing drive signal waveforms when writing 1-bit pixel data in the embodiment 3.

FIG. 20 is a view showing drive signal waveforms when writing 3-bit pixel data in the embodiment 3.

FIG. 21 is a view showing drive signal waveforms when displaying and rewriting image data in the embodiment 3.

FIG. 22 is an internal diagram of the pixel in the embodiment 4.

FIG. 23 is a view showing drive signal waveforms when writing 1-bit pixel data in the embodiment 4.

FIG. 24 is a view showing drive signal waveforms when displaying and rewriting image data in the embodiment 4.

FIG. 25 is an internal diagram of the pixel in the embodiment 5.

FIG. 26 is a view showing terminal voltage waveforms in the refresh operation in the embodiment 5.

FIG. 27 is an internal diagram of the pixel in the embodiment 6.

FIG. 28 is a block diagram of the image display terminal in the embodiment 7.

FIG. 29 is a block diagram of the TFT liquid crystal display panel using the prior art.

FIG. 30 is a block diagram of the TFT liquid crystal display panel using another prior art.

FIG. 31 is a plane view of the pixel in the embodiment 4.

### DETAILED DESCRIPTION OF THE PREFERRED EMBODIMENTS

(Embodiment 1)

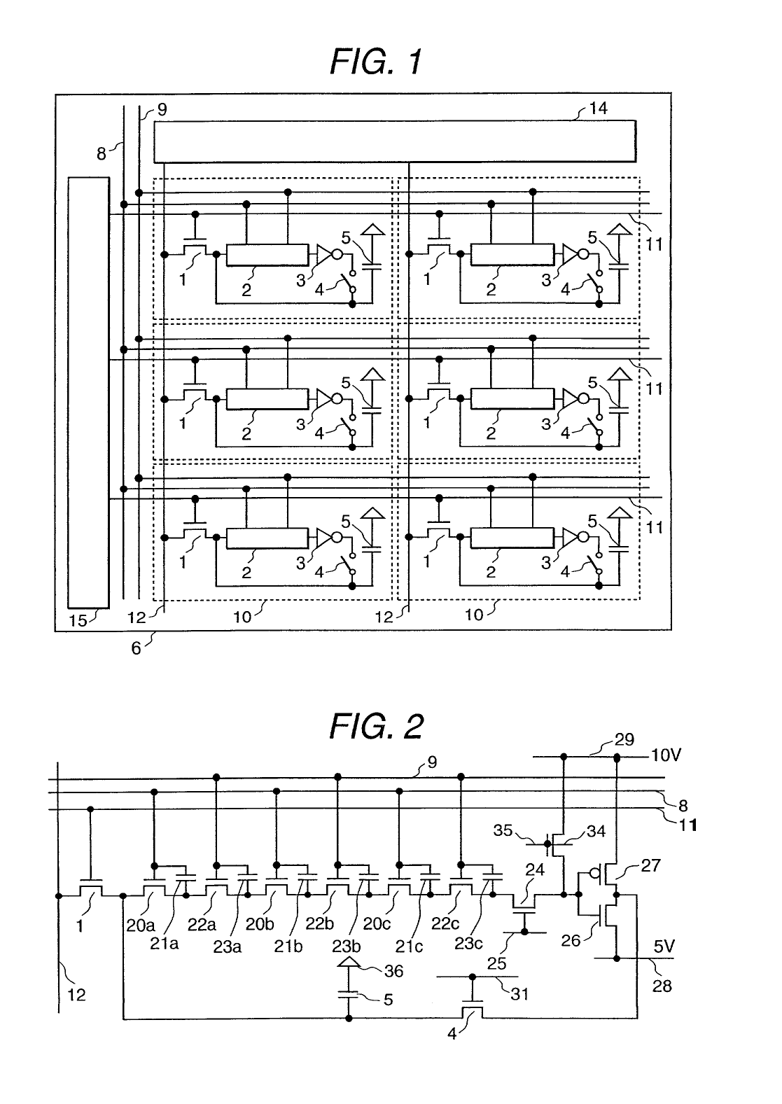

Referring to FIGS. 1 to 10, the embodiment 1 of the present invention is described.

At first, the overall configuration of this embodiment is described.

FIG. 1 is a configuration diagram of a poly Si-TFT liquid crystal display panel in this embodiment.

The pixels 10 having a liquid crystal capacitance 5 are arranged in a matrix geometry at the display part (only 6 pixels are shown in FIG. 1 for simplification), and the pixel 10 is connected to the gate line drive circuit 15 through the gate line 11 and connected to the signal line drive circuit 14 through the signal line 12. The pixel 10 has DRAM (Dynamic Random Access Memory) composed of the data input switch land the liquid crystal capacitance 5, and the other terminal of the data input switch 1 is connected to the signal line 12. The data hold node of DRAM is put into DDB (Bucket Brigate Device) 2 to be described later, and the output of BBD is put again into the data hold node of DRAM through the inverter 3 and the rewrite switch 4. BBD 2 of the individual pixel is connected commonly to the first BBD drive line 8 and the second BBD drive line 9. The above components are formed on the glass substrate 6.

The outline of the operation in this embodiment is described below.

As the gate line drive circuit 15 opens and closes the data input switch 1 for the designated pixel line through the gate line 1, the pixel data supplied on the signal line 12 by the signal line drive circuit 14 are put into DRAM composed of the data input switch 1 and the liquid crystal capacitance 5 for every individual 1-bit data. The liquid capacitance 5 can display the images with the image data written into DRAM. The image data written into DRAM are read out bit by bit into BBD by BBD 2 driven by the first BBD drive line 8 and the second BBD driveline 9. The individual pixel in this embodiment can display 3-bit data by using plural memories installed inside the pixel, and can store the image data having at most 3-bit length sequentially into BBD. Next, the image data stored in BBD are rewritten again into DRAM composed of the liquid crystal capacitance 5 through the inverter 3 and the rewrite switch 4. This operation is equivalent to the refresh of DRAM data, in which the image data changes its value between “H” and “L” owing to the operation of the inverter 3. By driving the liquid crystal common electrode (not shown) in synchronization to this rewrite operation, AC drive for the liquid crystal can be realized.

By employing the above configuration and operation, it will be appreciated that the data in DRAM can be refreshed periodically as well as 3-bit image data can be displayed with a simplified pixel configuration in this embodiment. Though a simplified DRAM circuit is used for the memory inside the pixel in this embodiment, any external operation for rewriting the image data is not required, and the signal line 12 is not required to be driven for the refresh operation.

Next, the detail structure of the pixel including BBD and its operation are described.

FIG. 2 is an internal structure of the pixel 10 in this embodiment.

DRAM composed of the data input switch 1 and the liquid crystal capacitance 5 is formed in the pixel 10, and the other terminal of the data input switch 1 is connected to the signal line 12. The component 36 is a liquid crystal common electrode. The 3-bit BBD 2 into which the image data are supplied from the data hold node of DRAM is composed of the data transfer part comprising switches 20a, 22a, 20b, 22b, 20c and 22c, and capacitances 21a, 23a, 21b, 23b, 21cand 23c, and the data output part comprising the output gate 24 and the reset switch 34. The output from BBD 2 is put into CMOS (Complementary MOS) inverter 3 composed of pMOS driver 27 and nMOS driver 26, and its output is put again into the data hold note of DRAM through the rewrite switch 4. As for the individual switches and capacitances of BBD 2, the switches 20a, 20b and 20c and the capacitances 21a, 21b and 21c are connected to the first BBD drive line 8, and the switches 22a, 22b and 23c and the capacitances 23a, 23b and 23c are connected to the second BBD drive line 9, respectively. The output gate 24 and the gates of the resent switch 34 and the rewrite switch 4 are connected to the output gate line 25, the reset gate line 35, and the rewrite gate line 31, respectively. The drain of the reset switch 34 and the high voltage terminal of CMOS inverter 3 are connected to 10V power supply line 29, and the low voltage terminal of CMOS inverter 3 is connected to 5V power supply line 28.

The operation of the pixels in this embodiment is described below.

In this embodiment, in the state that BBD is not operated, that is, the pixel memory is not used, multi-value mode display or analog mode display operations enabling motion picture display can be provided, which will be explained at first.

As described above, as the gate line drive circuit 15 opens and closes the data input switch 1 for the designated pixel line through the gate line 11, the image data supplied onto the signal line 12 by the signal line drive circuit 14 are put into the liquid crystal capacitance 5 through the data input switch 1. The rewrite switch 4 is kept off by the rewrite gate line 31. The image data rewrite operation in this state is equivalent to that in ordinary TFT liquid crystal displays, which enables multi-value mode display or analog mode display operations independently whether the liquid crystal common electrode is driven in DC mode or AC mode. In this case, an identical voltage is preferably applied down to 10V electric power line 29 and 5V electric power line 28 in order to reduce the electric power consumption. It is preferable to turn off always the first BBD drive line 8 and the second BBD drive line 9 in order to avoid parasitic effect in BBD.

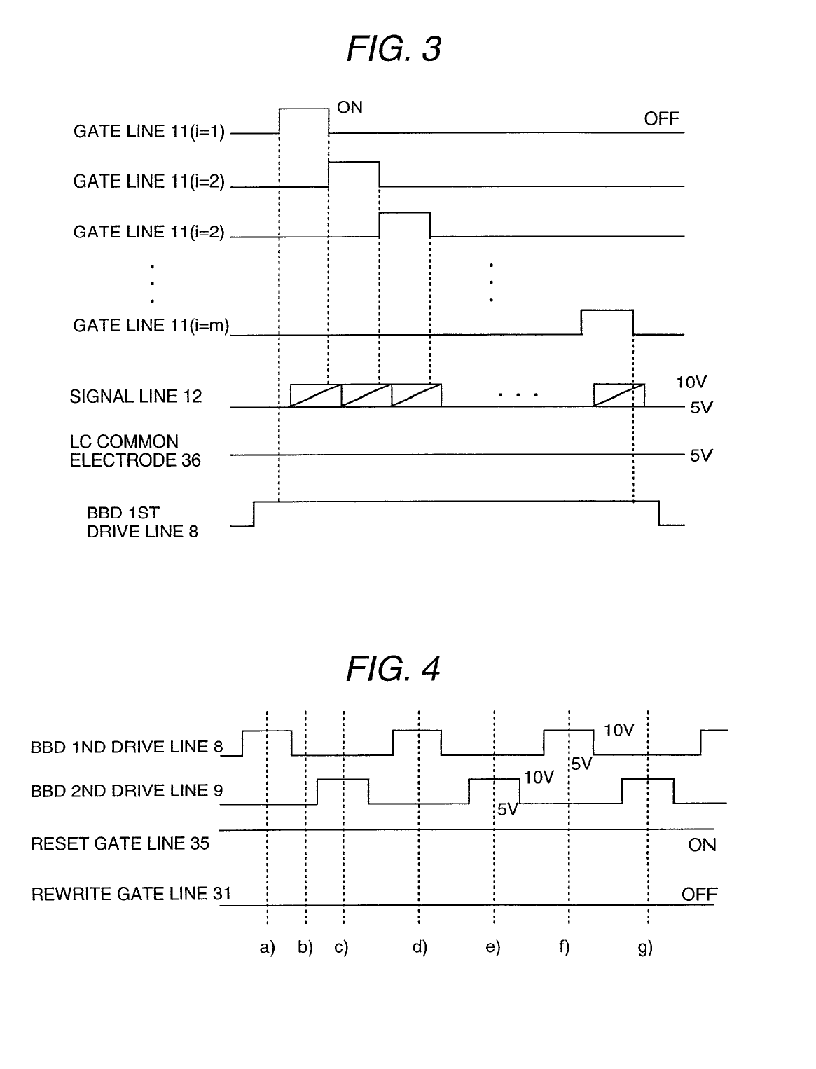

Next, by referring to FIGS. 3 to 6, the operation for writing the 3-bit digital image data into the pixel is described.

FIG. 3 shows drive signal waveforms on the gate line 11 (i corresponds to the row number of the gate line), arbitrary signal line 12, the liquid crystal common electrode 36, the first BBD drive line 8 when writing the 1-bit digital image data into the overall pixels, in which the number of pixels is assumed to be m rows. In the individual drawings in this specification, the upward direction in the waveform means an ON state or high voltage, and the downward direction in the waveform means an OFF state or low voltage. For writing 1-bit pixel data, the first BBD drive line 8 is turned on at first, and next, the data input switches for the individual rows scanned by the gate line 11 are turned on sequentially. Image data are put into the signal line 12 with a little delay to the drive pulse on the gate line 11. In the end of the above operations, writing 1-bit image data for the overall pixels scanned by the gate line 11 is completed. The voltage of the liquid crystal common electrode 36 has a constant value.

Next, the operation of the pixels when writing the 3-bit digital image data is described.

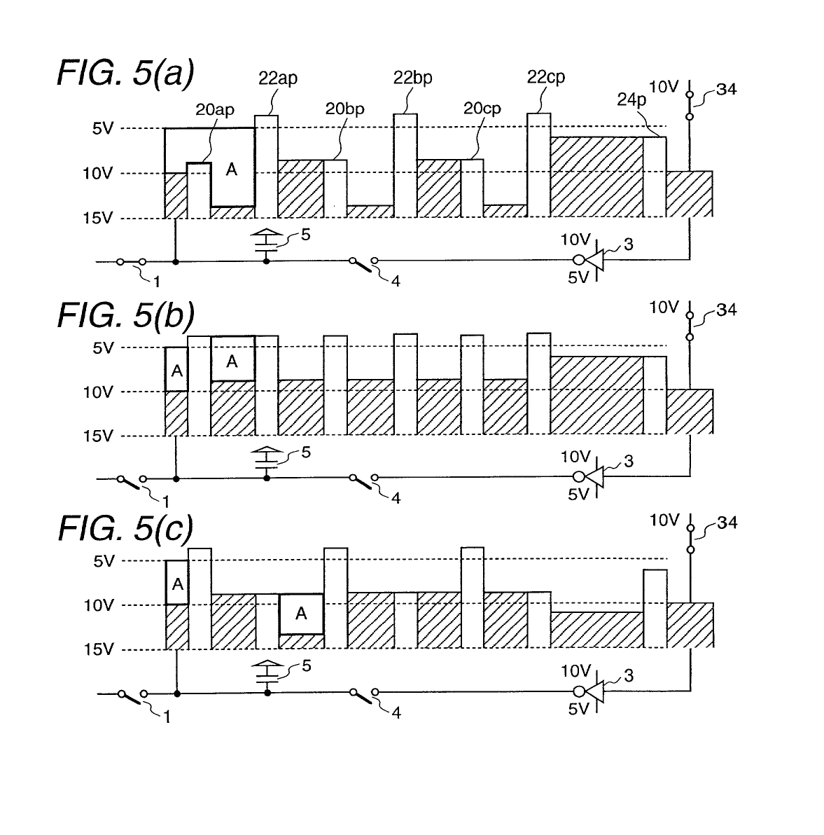

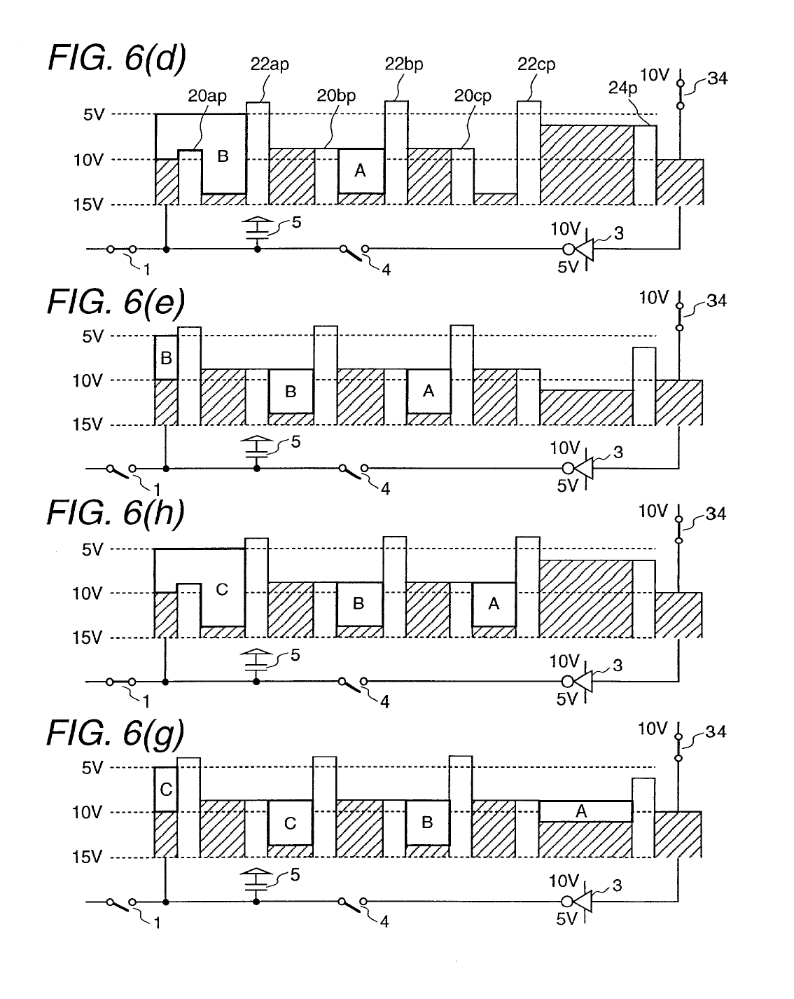

FIG. 4 shows drive signal waveforms on the first BBD drive line 8, the second BBD drive line 9, the reset gate line 35 and the rewrite gate line 31. FIGS. 5 and 6 show channel potentials of BBD at the individual points at a) to g). In this figure, the downward direction in the potential means positive values. The channel potentials at the switches 20a, 22a, 20b, 22b, 20c and 22c and the output gate 24 are illustrated by the lines 20ap, 22ap, 20bp, 20cp, 22cp and 24p. The symbols A, B and C mean the signal charge (equivalent to electrons in this example) representing 3-bit image data at the individual pixel, and the levels of data, “L” and “H” direct an existence of the signal charges. For the convenience in explanation, all the signal charges in A, B and c are explicitly illustrated in the figure.

By referring to FIGS. 5 and 6, the drive signal waveforms and the changes in the channel potentials in BBD for the individual points at a) to g) shown in FIG. 4 are described. When writing 3-bit image data, the reset switch 34 driven by the reset gate line 35 is always in an On state for all the points from a) to g) and thus continues to clear the charge supplied form BBD, and at the same time, the rewrite switch 4 driven by the rewrite gate line 31 is turned off, which inhibits the rewrite operation of the output of the inverter 3 for the liquid crystal capacitance 5.

By referring to FIG. 4 and FIG. 5a), b) and c), the operation for reading 1-bit digital pixel data from the signal line 12 to BBD2 in the pixel is described at first.

a): This case corresponds to the state that the first BBD drive line 8 is ON and the second BBD drive line 9 is OFF, that is, the case of the timing of writing 1-bit image data to the individual pixels described by referring to FIG. 3. As the switch 20a is turned on, the signal charge A supplied through the data input switch 1 from the signal line 12 when the gate line 11 is made ON is also supplied to and held at the capacitance 21a as well as the liquid crystal capacitance 5.

b): The switch 20a is turned on as the first BBD drive line 8 is turned off, and then, the signal charge A is kept between a couple of potential walls, 20ap and 22ap.

c); The signal charge A transfers through the switch 22a to the capacitance 23a as the second BBD drive line 9 is turned on, and then kept between a couple of potential walls, 22ap and 20bp.

Next, by referring to FIG. 4 and FIGS. 6d), e), f) and g), the operation for reading the consecutive 2-bit digital pixel data is described.

d): This case also corresponds to the state that the first BBD drive line 8 is ON and the first BBD drive line 9 is OFF, that is, the case of the timing of writing 1-bit image data to the individual pixels described by referring to FIG. 3. As the switch 20a is turned on, the signal charge B supplied through the data input switch 1 from the signal line 12 when the gate line 11 is made ON is also supplied to and held at the capacitance 21a as well as the liquid crystal capacitance 5. At the same time, the signal charge A transfers through the switch 20bto the capacitance 21b, and then kept between a couple of potential walls, 20bp and 22bp.

e): This case also corresponds to the state that the first BBD drive line 8 is OFF and the first BBD drive line 9 is ON, in which the signal charge A transfers through the switch 22b to the capacitance 23b and kept between a couple of potential walls, 22bp and 20cp.

f): This case also corresponds to the state that the first BBD drive line 8 is ON and the first BBD drive line 9 is OFF, that is, the case of the timing of writing 1-bit image data to the individual pixels described by referring to FIG. 3. As the switch 20a is turned on, the signal charge C supplied through the data input switch 1 from the signal line 12 when the gate line 11 is made ON is also supplied to and held at the capacitance 21a as well as the liquid crystal capacitance 5. At the same time, the signal charge A transfers through the switch 20b to the capacitance 21b, and then kept between a couple of potential walls, 20bp and 22bp. At the same time, the signal charge A transfers through the switch 20c to the capacitance 21c, and then kept between a couple of potential walls, 20cp and 22cp.

g): This case also corresponds to the state that the first BBD drive line 8 is OFF and the first BBD drive line 9 is ON, in which the signal charge C transfers through the switch 22a to the capacitance 23a and kept between a couple of potential walls, 22ap and 20bp. At the same time, the signal charge B transfers through the switch 22b to the capacitance 23b and kept between a couple of potential walls, 22bp and 20cp. At the same time, the signal charge A transfers through the switch 22c to the capacitance 23c and kept between a couple of potential walls, 22cp and 24p.

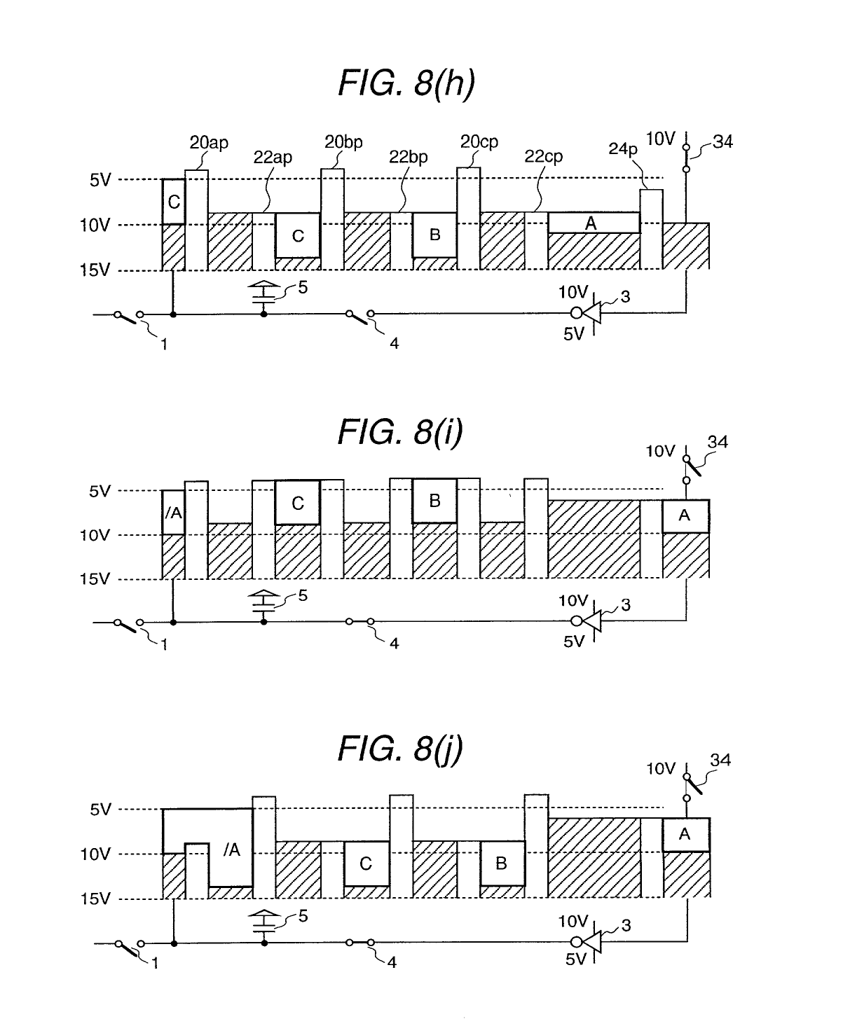

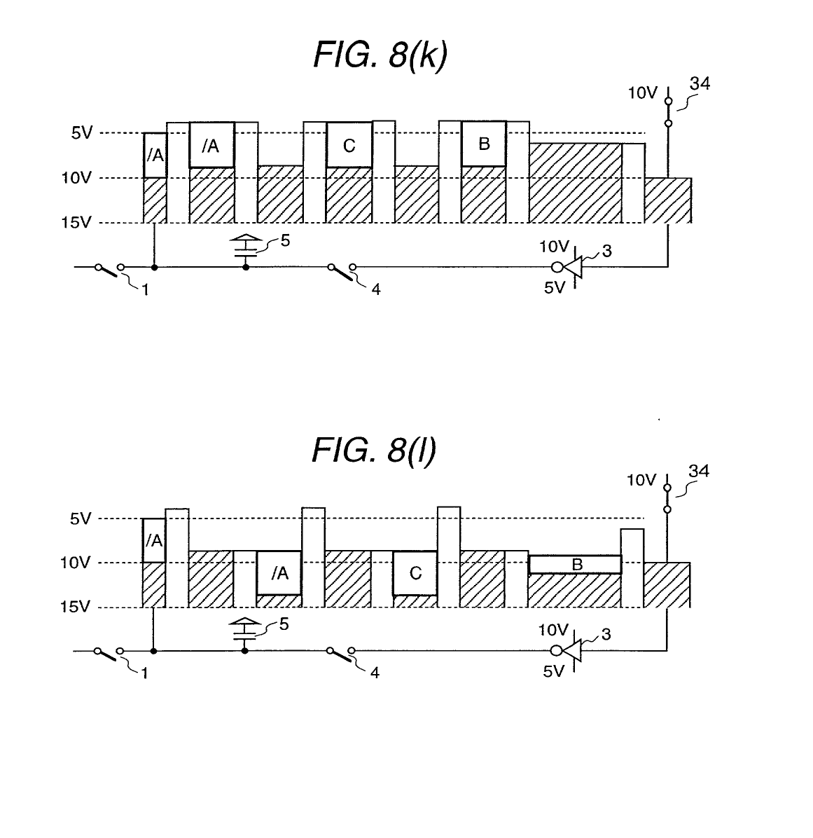

Reading 3-bit digital pixel data into the pixels is completed in the end of the above described operations. Though it is not explicitly recognized from FIG. 5 and FIG. 6, the capacitance value of the capacitance 23c is larger than the values of BBD capacitances 21a, 23a, 21b, 23b and 21c, and is designed to be approximately twice as large as the value for another BBD capacitances in this embodiment. This will be described again in the explanation by referring to FIG. 8.

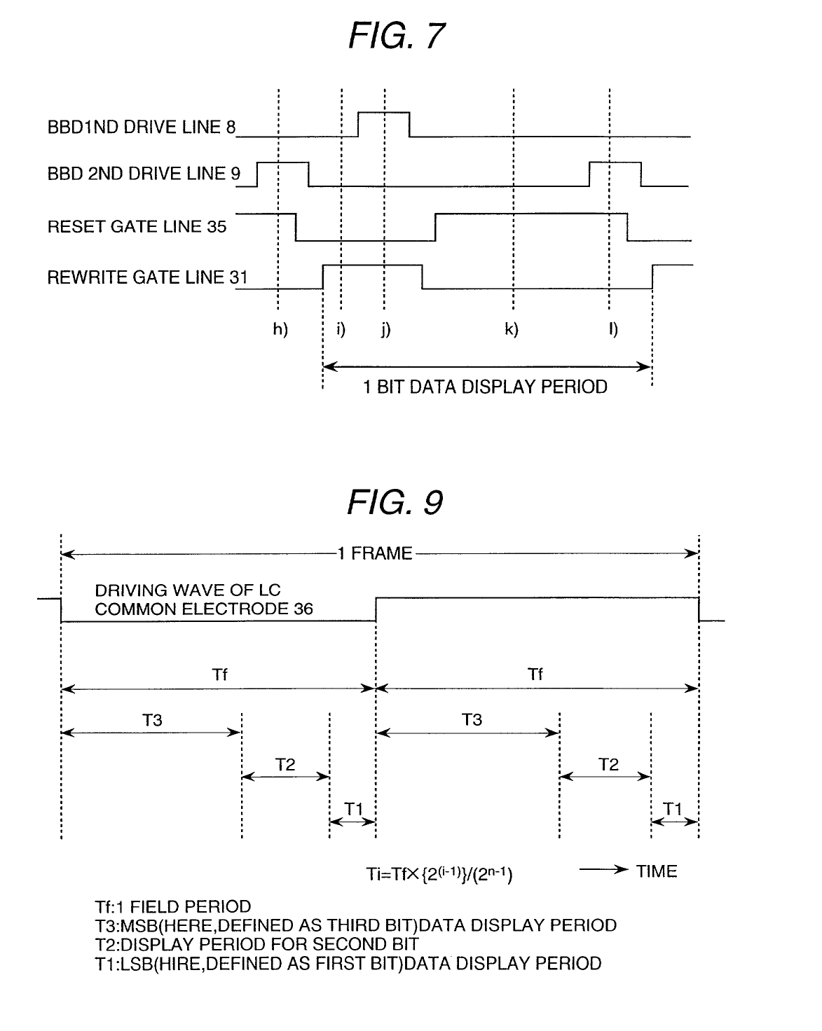

Next, the operations for displaying and rewriting 3-bit digital image data at the pixels are described below by referring to FIGS. 7 to 9.

FIG. 7 shows drive signal waveforms on the first BBD drive line 8, the second BBD drive line 9, the reset gate line 35 and the rewrite gate line 31 in the operations of displaying and rewriting the 3-bit digital image data. FIG. 8 shows channel potentials of BBD at the individual points at h) to l) shown in FIG. 7. In this figure, the downward direction in the potential means positive values. The channel potentials at the switches 20a, 22a, 20b, 22b, 20c and 22c and the output gate 24 are illustrated by the lines 20ap, 22ap, 20bp, 20cp, 22cp and 24p. The symbols A, B and C mean the signal charge representing 3-bit image data at the individual pixel, and the levels of data, “L” and “H”, direct an existence of the signal charges. The symbol, /A, means a reverse signal of A, and if there is a signal charge in A, for example, there is no signal charge in /A. However, for the convenience in explanation, the signal charge /A is also illustrated hypothetically in the physical existence as well as signal charges A, B and C in the figure.

By referring to FIGS. 7 and 8, the drive signal waveforms the changes in the channel potentials in BBD for the individual points at h) to l) are described. For all the points from h) to l), the gate line 11 and the data input switch 1 controlled by this line are made OFF, and the DC voltage is applied to the signal line 12 or the signal line 12 is grounded in order to prevent the electric power consumption.

h): This case also corresponds to the state that the first BBD drive line 8 is OFF and the first BBD drive line 9 is ON. The signal charge C is kept between a couple of potential walls, 22ap and 20bp, the signal charge B is kept between a couple of potential walls, 22bp and 20cp, and the signal charge C is kept between a couple of potential walls, 22cp and 24p.

i): Next, the reset switch 34 is turned off by the reset gate line 35, and then the input terminal of the inverter 3 is floating, and next, the signal charge A is flowing over the potential wall 24p of the output gate 24 and supplied to the input terminal of the inverter 3. As a constant voltage is always applied o the output gate line 25, it should be noted that the level of the potential wall 24p has a constant value. The reason why a constant potential is provided to the potential wall 24p is to reduce the voltage level at the output terminal of BBD, in which the resultant potential amplitude of the capacitance 23c becomes smaller than the value of other BBD capacitances. In order to prevent the overflow in the signal charge from the capacitance 23c in this time, it is required to make the value of the capacitance 23c larger than the value of other BBD capacitances. In this embodiment, as described before, the value of the capacitance 23c is so designed as to be approximately twice as large as the value of other BBD capacitances. As the signal charge A is supplied to the inverter 3, the inverter 3 outputs the inverted signal of A, that is, /A. Its output voltage is 10V when there exists a signal charge A with which the input voltage to the inverter 3 is approximately 6V, and its output voltage is 5V when there does not exit a signal charge A in which the input voltage to the inverter 3 is 10V for the reset state. In the next step, as the rewrite switch 4 is turned on by the rewrite gate line 31, the output voltage of the inverter 3 is applied to the liquid crystal capacitance 5 and the input terminal of BBD 2, and then, used for display.

j): Next, by means that the first BBD drive line 8 is made ON, as the switch 20a is ON, the signal charge /A supplied through the rewrite switch 4 from the inverter 3 is also input to the capacitance 21a as well as the liquid crystal capacitance 5. At the same time, the signal charge C transfers through the switch 20b to the capacitance 21b, and kept between a couple of potential walls, 20bp and 22bp. At the same time, the signal charge B transfers through the switch 20c to the capacitance 21c, and kept between a couple of potential walls, 20cp and 22cp.

k): By means that the first BBD drive line 8 is made OFF, the switch 20a is turned off, and then the signal charge /A is kept between a couple of potential walls, 20ap and 22ap. Next, as the rewrite switch 4 is turned off by the rewrite gate line 31, the output of the inverter 3 is isolated from the liquid crystal capacitance 5, and the liquid crystal capacitance 5 holds the display output corresponding to the signal charge /A. Thereafter, as the reset switch is turned on by the reset gate line 35, the signal charge A is reset and the input of the inverter 3 returns again to 10V.

l): By means that the second BBD signal line 9 is made ON, the signal charge /A transfers through the switch 22a to the capacitance 23a, and is kept between a couple of potential walls, 22ap and 20bp. At the same time, the signal charge C transfers through the switch 22b to the capacitance 23b, and is kept between a couple of potential walls, 22bp and 20cp. At the same time, the signal charge B transfers through the switch 22c to the capacitance 23c, and is kept between a couple of potential walls, 22cp and 24p. This state is such a state that the signal charges are shifted forward by 1-bit from the state shown in h).

In this embodiment, by repeating the operations h) to l), the output for the 3-bit digital image data can be displayed sequentially as well as the rewrite operation equivalent to the refresh operation of DRAM can be performed simultaneously inside the pixel without using the signal line 12 having a large parasitic capacitance with lower electric power consumption. In this embodiment, every time when the rewrite operation of 3-bit data into the liquid crystal capacitance 5 is completed in the end of a single data loop, the voltage applied to the liquid crystal common electrode 36 is made inverted. With this operation, AC drive of the liquid crystal capacitance 5 is realized as described before in referring to FIG. 1.

Even by displaying repetitively 3-bit digital image data simply at a constant rate, 4-level gray scale image can not be displayed. In this embodiment, in order to solve this problem, 8-level (2 to the power of 3) gray scale image display can be established by altering the display periods for three set of single-bit data so as to increase twice as long as one another. This operation will be described by referring to FIG. 9.

FIG. 9 shows a display sequence for 3-bit display data in a single frame period in this embodiment. The single frame period is composed of a couple of fields, in which the voltage applied to the liquid crystal common electrode 36 alters from one field to another. In the individual field period, three sets of bit data are displayed for the display periods having their own length extended stepwise twice as the time goes on. The first bit (LSB: Least Significant Bit) is displayed for the period corresponding to 1/7 of the individual field period, the second bit is displayed for the period corresponding to 2/7 of the individual field period, and the third bit is displayed for the period corresponding to 4/7 of the individual field period, respectively. The display period for the i-th bit for displaying n-bit data is defined by the following equation.

[Formula 1]

Ti=Tf×{2⁽ⁱ⁻¹⁾}/(2ⁿ−1),

in which Ti is the display period of the i-th bit, and Tf is the length of the single field period.

The length of the single field period is half of the length of the single frame period, and its frame frequency is preferably defined so as to reduce flickers due to AC voltage drive and gray scale display in the liquid crystal. For example, the frame frequency is defined to be 60 Hz in this embodiment.

Though the waveform of the drive signal for the liquid crystal common electrode 36 is made consistent with the single frame period as shown in FIG. 9 in this embodiment, this drive signal may be made reversed for every bit and used for driving the electrode. In this case, for example, the drive signal to the liquid crystal common electrode 36 changes so as to be “H” for the period T3, “L” for the period T2, and “H” for the period T1 at first, and then “L” for the period T3, “H” for the period T2 and “L” for the period T1 in the next phase. Owing to this way of driving, there is such an advantage that flickers can be reduced even in making the length of the single frame period relatively longer.

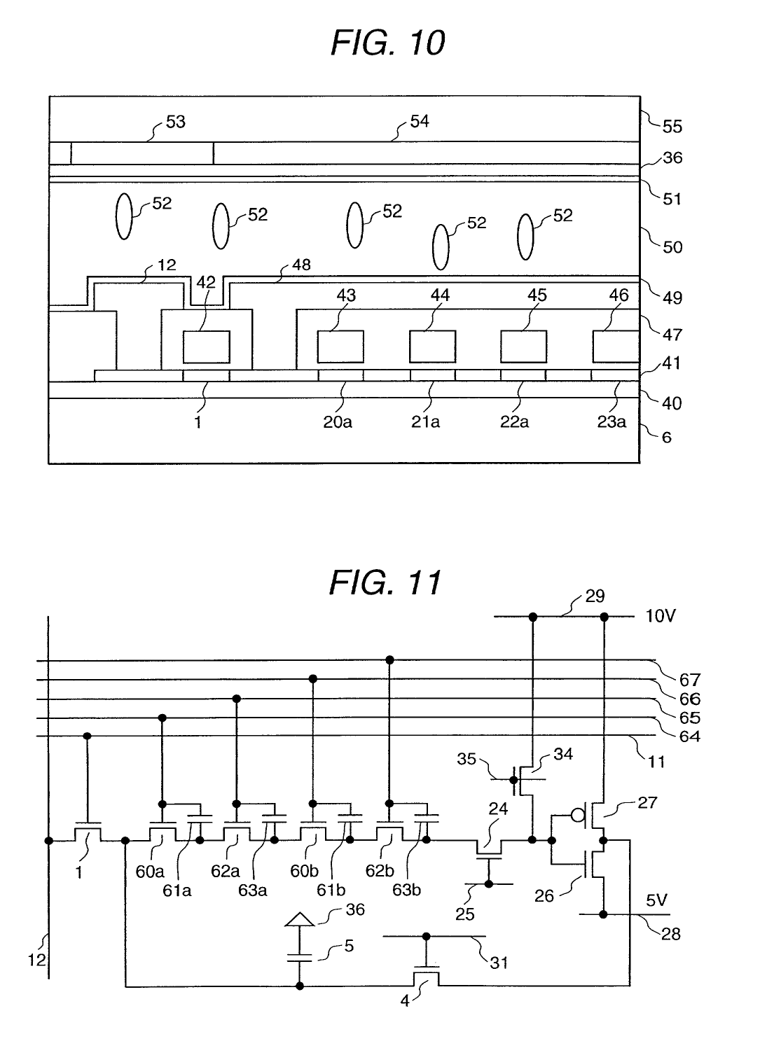

Next, the device structures for the individual switches and BBD in this embodiment is described by referring to FIG. 10.

FIG. 10 shows a cross-sectional view of a part of the pixel in this embodiment. polycrystalline Silicon (poly-Si) films 41 are formed on the glass substrate 5, between which the buffer film 40 is inserted, and furthermore the electrodes 42, 43, 44, 45 and 46 and the insulation film 47 are formed on the poly-Si film 41. The electrode 42 is defined as the gate electrode of the data input switch 1, the electrode 43 is defined as the gate electrode of the switch 20a of BBD 2, the electrode 44 is defined as the upper electrode of the capacitance 21a of BBD 2, the electrode 45 is defined as the gate electrode of the switch 22a of BBD 2, and the electrode 46 is defined as the upper electrode of the capacitance 23a of BBD 2. The signal line 12 and the pixel electrode 48 are provided at the both terminals of the data input switch 1, on which oriented film 49 is formed furthermore. The color filter 54 and the light-block film 53 are formed on the opposed glass substrate 55, on which the transparent liquid crystal common electrode 36 using ITO (Indium Tin Oxide) and the oriented film 51 are formed. The liquid film layers 50 containing liquid crystal molecules 52 are filled on the glass substrate 6 and in between the opposed glass substrates 55, which resultantly establishes the liquid crystal capacitance5 between the pixel electrode 48 and the liquid crystal common electrode 36.

As apparent from above, the data input switch 1 is composed of poly-Si TFT (Thin-Film-Transistor), and the channel for the data input switch 1 and BBD 2 is formed by poly-Si thin film as well. The electrodes 42, 43, 44, 45 and 46 of the data input switch 1 and BBD 2 are formed by conductive electrode layer composed of an identical material. In this embodiment, the simplification in the manufacturing process and the downsizing of the cost can be attained by using common materials as the composition for the data input switch 1 and BBD 2. An identical threshold voltage (Vth) is defined for the channels below the gates of the data input switch 1 and the switches 20a, 22a, 20b, 22b, 20c and 22c by an identical process for implanting impurities, and high concentration impurities are doped into the poly-Si layers for the capacitances 21a, 23a, 21b, 23b, 21c and 23 for preventing depletion.

The extension of the pixel electrode 48 over BBD2 is aimed for providing the pixel electrode 48 as the reflection electrode for the external light, and thus, scattering characteristics for the incoming light can be provided by making its surface concavo-convex, if required. By applying the above described structure, reflection-type liquid crystal display can be established in this embodiment. Though it is not shown in the figure, the pixel electrode 48 covers approximately half of the overall pixel, and the rest half part is formed as a transparent electrode using ITO. A designated back-light device (not shown) is formed below the glass substrate 6, and by switching this back-light device properly, transmission-type liquid crystal display can be also established by this apparatus.

Various modifications can be made in the embodiment described without departing from the spirit and scope of the present invention. Though the glass substrate 6 is used as TFT substrate in this embodiment, translucent insulating substrate such as quartz-base substrate or translucent plastic substrate can be used alternatively, and reflection-type liquid crystal display is exclusively employed in stead of transmission-type liquid crystal display, with which opaque substrates can be used.

As for TFT and BBD, though nMOS is used for he data input switch 1 in this embodiment, proper modifications necessary for the drive signal waveform can make it possible to substitute pMOS and CMOS for this composition material. As for the inverter 3, another type of inverter other than CMOS inverter can be of course used.

In this embodiment, as described above, by means that the channels and electrodes for the data input switch 1 and BBD 2 are formed by identical processes, and that the composition materials for the data input switch 1 and BBD 2 are made of common materials, the simplification of the manufacturing processes and the downsizing in the cost can be attained. It is, however, not necessary to make those composition materials applied to the individual components in order to attain such an effect as defined as the object of the present invention.

In the description of this embodiment, the number of pixels and the size of the panel are not referred to. This is because the present invention is not limited to those parameter specifications and formats. Though the display performance is defined as 3-bit 8-gray scales for using DRAM pixel memories in this embodiment, the present invention is not limited to any specific bit length only by varying the number of channels of BBD 2. As for the drive voltage in the pixel part, its optimal voltage may be of course determined on the basis of the material used for the liquid crystal, its drive scheme, and the design parameters of the external electric power source.

Various modifications described above may be basically applied similarly to another embodiments other than this embodiment.

(Embodiment 2)

Next, the embodiment 2 of the present invention is described by referring to FIGS. 11 to 17.

The overall configuration and its operations of this embodiment is basically equivalent to those of the embodiment 1 described by referring to FIG. 1 excluding the structure of BBD (Bucket Brigade Device) 2 and its drive method. Thus, the overall configuration and its operations are not described in detail, but the pixels and BBD featuring this embodiment is mainly described below.

A detail structure of the pixel 10 including BBD and its operations are described in this embodiment.

FIG. 11 shows an internal structure of the pixel in this embodiment.

DRAM composed of the data input switch 1 and the liquid crystal capacitance 5 is formed in the pixel 10, and the terminal of the data input switch 1 is connected to the signal line 12. The component 36 is a liquid crystal common electrode. BBD for storing 3-bit data supplied from the data hold node of DRAM is composed of the data transfer part comprising switches 60a, 62a, 60b and 62b, and capacitances 61a, 63a, 61b and 63b, and the data output part comprising the output gate 24 and the reset switch 34. The output of BBD is input to CMOS (Complementary MOS) inverter 3 composed of the pMOS driver 27 and the nMOS driver 26, and its output is input again to the data hold node of DRAM through the rewrite switch 4. The individual switches and their capacitances of BBD are different from those in the embodiment 1, in which the switch 60a and the capacitance 61a are connected to the first BBD drive line 64, the switch 62a and the capacitance 63 are connected to the second BBD drive line 65, the switch 60b and the capacitance 61b are connected to the third BBD drive line 66, and the switch 62b and the capacitance 63b are connected to the forth BBD drive line 67, respectively. The output gate 24 and the gates of the reset switch 34 and the rewrite switch 4 are connected to the output gate line 25, the reset gate line 35 and the rewrite gate line 31, respectively. The drain of the reset switch 34 and the high-voltage terminal of CMOS inverter 3 are connected to the 10V electric power line 29, and the low-voltage terminal of CMOS inverter 3 is connected to the 5V electric power line 28.

Now, the operations of the pixel in this embodiment is described below.

As ordinary multi-value display or analog display operations in this embodiment in case that BBD is not operated, that is, the pixel memory is not used, are similar to the first embodiment, those operations are not described here. In case that the pixel memory is not used, the rewrite switch 4 may be always turned off by the write gate line 31, and thus, an identical lower voltage is preferably applied down to the electric power line 29 and the 5V electric power line 28 in order to reduce the electric power consumption. It is preferable to turn off always the first BBD drive line 64 and the second BBD drive line 65, the third BBD drive line 66 and the forth BBD drive line 67 in order to avoid parasitic effect in BBD.

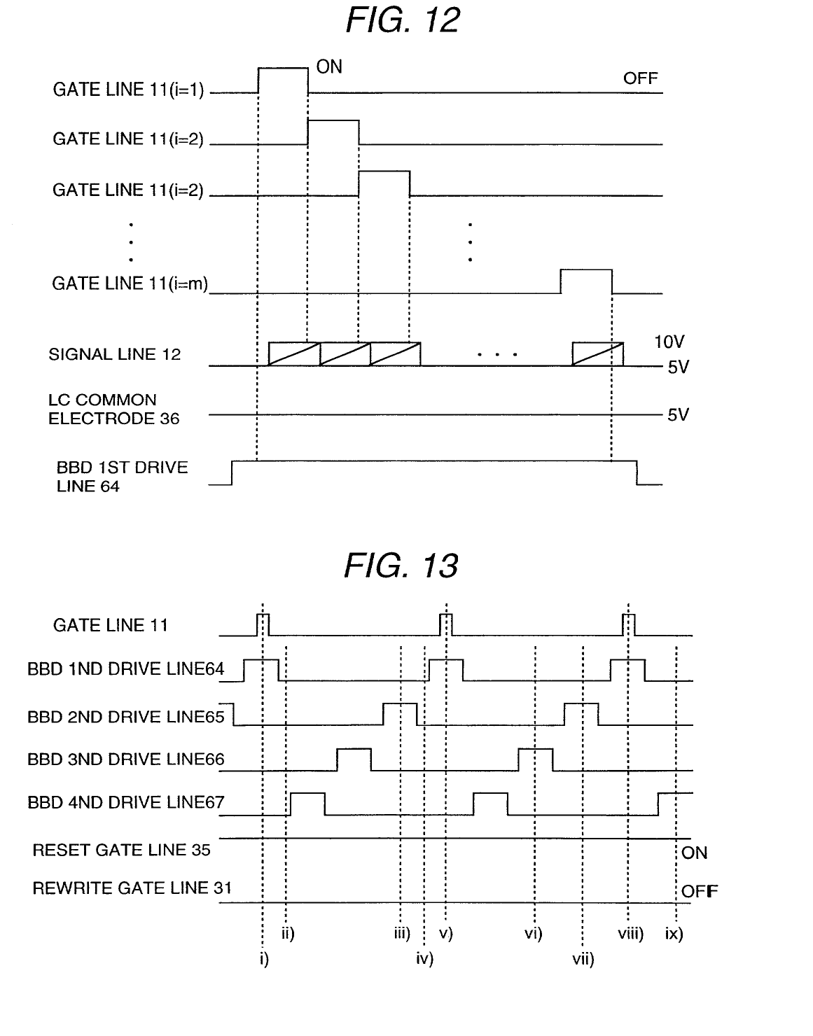

Next, by referring to FIGS. 12 to 15, the operation for writing the 3-bit digital image data into the pixel is described.

FIG. 12 shows drive signal waveforms on the gate line 11, arbitrary signal line 12, the liquid crystal common electrode 36, and the first BBD drive line 64 when writing the 1-bit digital image data into the overall pixels, in which the number of pixels is assumed to be m rows. In the individual drawings in this specification, the upward direction in the waveform means an ON state or high voltage, and the downward direction in the waveform means an OFF state or low voltage. For writing 1-bit pixel data, the first BBD drive line 64 is turned on at first, and next, the data input switches for the individual rows scanned by the gate line 11 are turned on sequentially. Image data are put into the signal line 12 with a little delay to the drive pulse on the gate line 11. In the end of the above operations, writing 1-bit image data for the overall pixels scanned by the gate line 11 is completed.

Next, the operation of the pixels when writing the 3-bit digital image data is described.

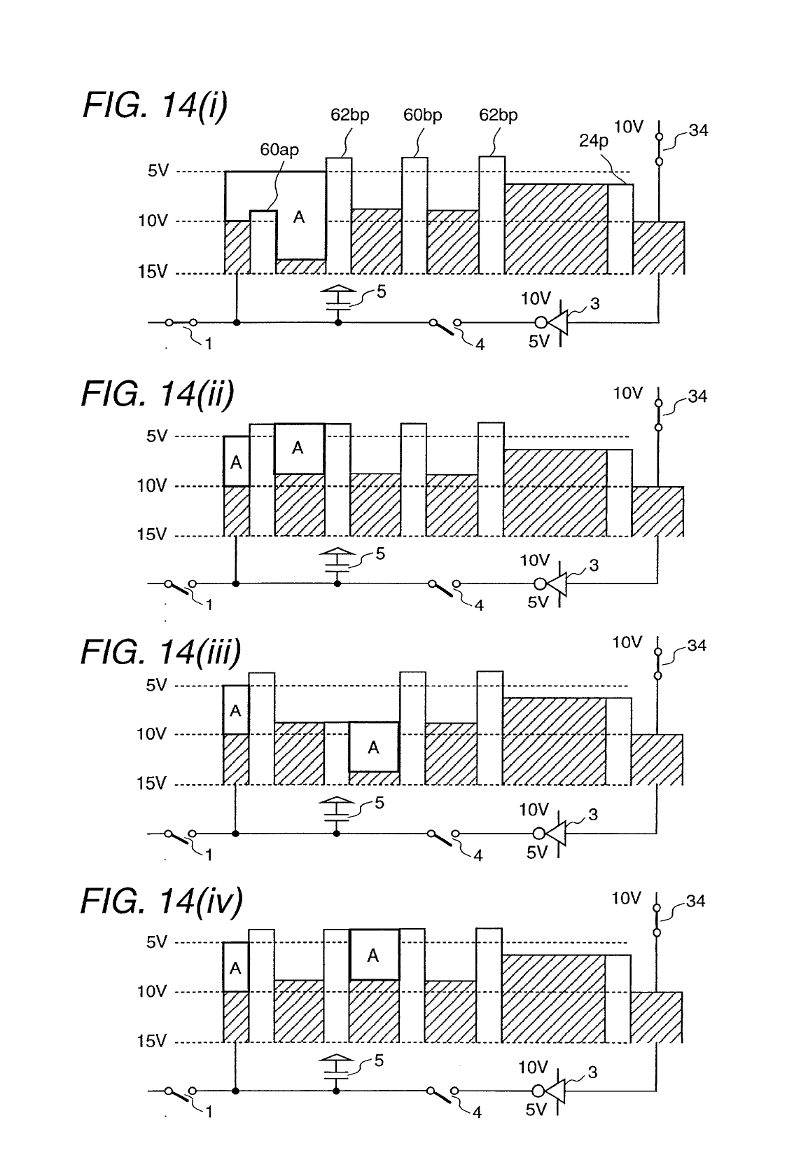

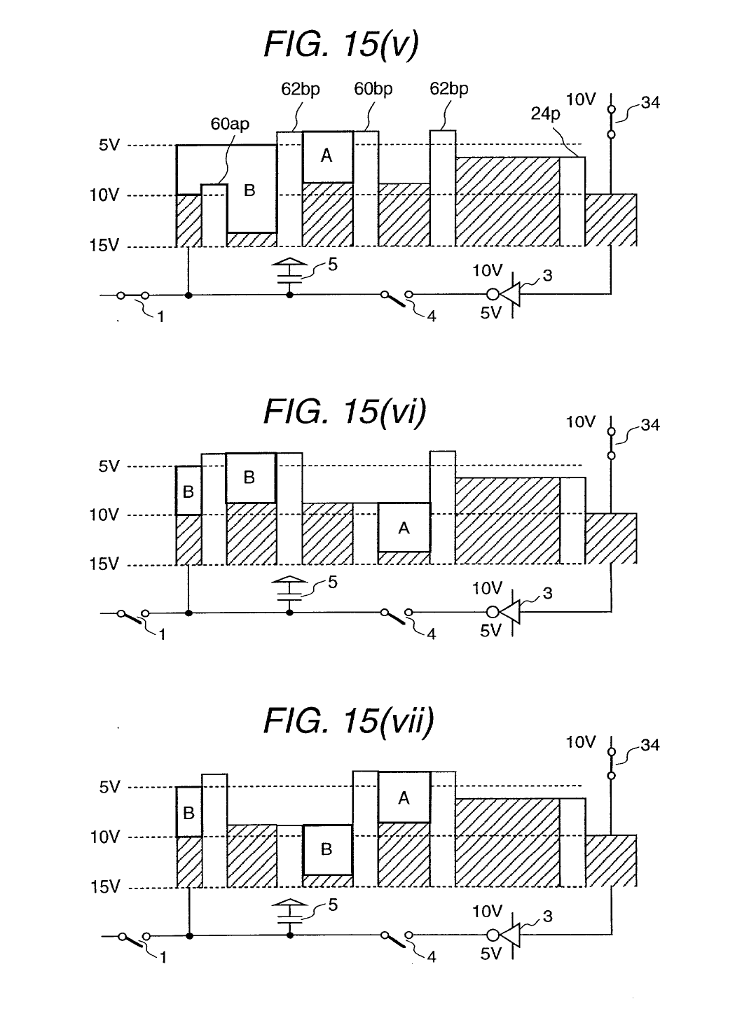

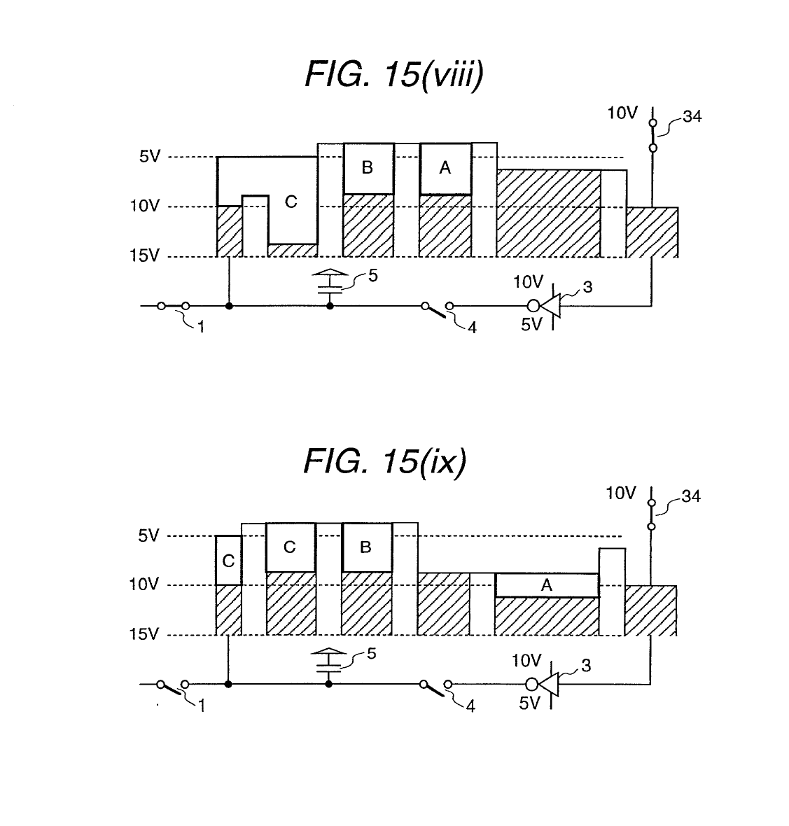

FIG. 13 shows drive signal waveforms on the gate line 11, the first BBD drive line 64, the second BBD drive line 65, the third BBD drive line 66, the forth BBD drive line 67, the reset gate line 35 and the rewrite gate line 31. FIGS. 14 and 15 show channel potentials of BBD at the individual points at i) to ix). In this figure, the downward direction in the potential means positive values. The channel potentials at the switches 60a, 62a, 60b, 62b and the output gate 24 are illustrated by the lines 60ap, 62ap, 60bp, 62cp and 24p. The symbols A, B and C mean the signal charge representing 3-bit image data at the individual pixel, and the levels of data, “L” and “H” direct an existence of the signal charges. For the convenience in explanation, all the signal charges in A, B and C are explicitly illustrated in the figure.

By referring to FIGS. 14 and 15, the drive signal waveforms and the changes in the channel potentials in BBD for the individual points at i) to ix) shown in FIG. 13 are described. When writing 3-bit image data, the reset switch 34 driven by the reset gate line 35 is always in an On state, and the rewrite switch 4 driven by the rewrite gate line 31 is turned off for all the points from i) to ix), and thus they continue to clear the charge supplied form BBD, and at the same time inhibit the rewrite operation of the output of the inverter 3.

By referring to FIG. 13 and FIG. 14 i), ii), iii) and iv), the operation for reading 1-bit digital pixel data from the signal line 12 to BBD in the pixel is described at first.

i): This case corresponds to the state that the first BBD drive line 64 is ON and the second, third and forth BBD drive lines 65, 66 and 67 are OFF, that is, the case of the timing of writing 1-bit image data to the individual pixels described by referring to FIG. 12. As the switch 60a is turned on, the signal charge A supplied through the data input switch 1 from the signal line 12 when the gate line 11 is made ON is also supplied to and held at the capacitance 61a as well as the liquid crystal capacitance 5.

ii): The switch 60a is turned off as the first BBD drive line 64 is turned off, and then, the signal charge A is kept between a couple of potential walls, 60ap and 62ap.

iii): The signal charge A transfers through the switch 62a to the capacitance 63a as the second BBD drive line 65 is turned on, and then kept between a couple of potential walls, 62ap and 60bp. In this time, though the forth and third BBD drive lines 67 and 66 are turned on and off sequentially in a practical sense, its detail operation is not described because this operation is due to the flushing of the residual charges in BBD and hence has no relation to the writing of the signal charge A.

iv): The switch 62a is turned off as the second BBD drive line 65 is turned off. The signal charge A is still kept between a couple of potential walls, 62ap and 60bp.

Next, by referring to FIG. 3 and FIGS. 5 v), vi), vii), viii) and ix), the operation for reading the consecutive 2-bit digital pixel data is described.

v}: This case also corresponds to the state that the first BBD drive line 64 is ON and the second, third and forth BBD drive lines 65, 66 and 67 are OFF, that is, the case of the timing of writing 1-bit image data to the individual pixels described by referring to FIG. 12. As the switch 60a is turned on, the signal charge B supplied through the data input switch 1 from the signal line 12 when the gate line 11 is made ON is also supplied to and held at the capacitance 61a as well as the liquid crystal capacitance 5. The signal charge A is still kept between a couple of potential walls 62ap and 60bp.

vi): The third BBD drive line 66 is ON, and the first, second and forth BBD drive lines 64, 65 and 67 are OFF. The signal charge B is kept between a couple of potential walls 60ap and 562ap. The signal charge A transfers through the switch 60b to the capacitance 61b, and then kept between a couple of potential walls 60bp and 62bp.

vii): The second BBD drive line 65 is ON, and the first, third and forth BBD drive lines 64, 66 and 67 are OFF. The signal charge B transfers through the switch 62a to the capacitance 63a, and then kept between a couple of potential walls 62ap and 60bp. The signal charge A is still kept between a couple of potential walls 60bp and 62bp.

viii): This case also corresponds to the state that the first BBD drive line 64 is ON and the second, third and forth BBD drive lines 65, 66 and 67 are OFF, that is, the case of the timing of writing 1-bit image data to the individual pixels described by referring to FIG. 12. As the switch 60a is turned on, the signal charge C supplied through the data input switch 1 from the signal line 12 when the gate line 11 is made ON is also supplied to and held at the capacitance 61a as well as the liquid crystal capacitance 5. The signal charge B is still kept between a couple of potential walls 62ap and 60bp. The signal charge A is still kept between a couple of potential walls 60bp and 62bp.

ix): The forth BBD drive line 67 is ON, and the first, second and third BBD drive lines 64, 65 and 66 are OFF. The signal charge C is kept between a couple of potential walls 60ap and 62ap. The signal charge B is still kept between a couple of potential walls 62ap and 60bp. The signal charge A transfers through the switch 62b to the capacitance 63b, and kept between a couple of potential walls 62bp and 24p.

Reading 3-bit digital pixel data into the pixels is completed in the end of the above described operations. In the similar manner to the capacitance 23c in the embodiment 1, the value of the capacitance 63b is larger than the values of another BBDS, and is designed to be approximately twice as large as the values for another BBDs in this embodiment.

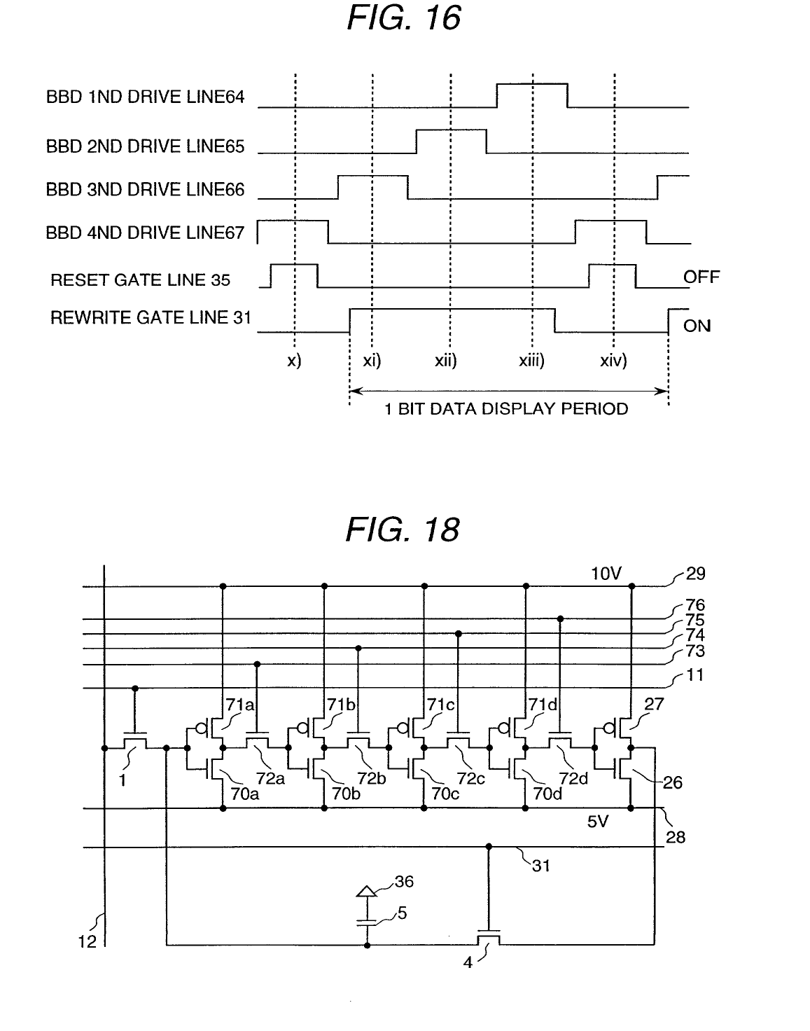

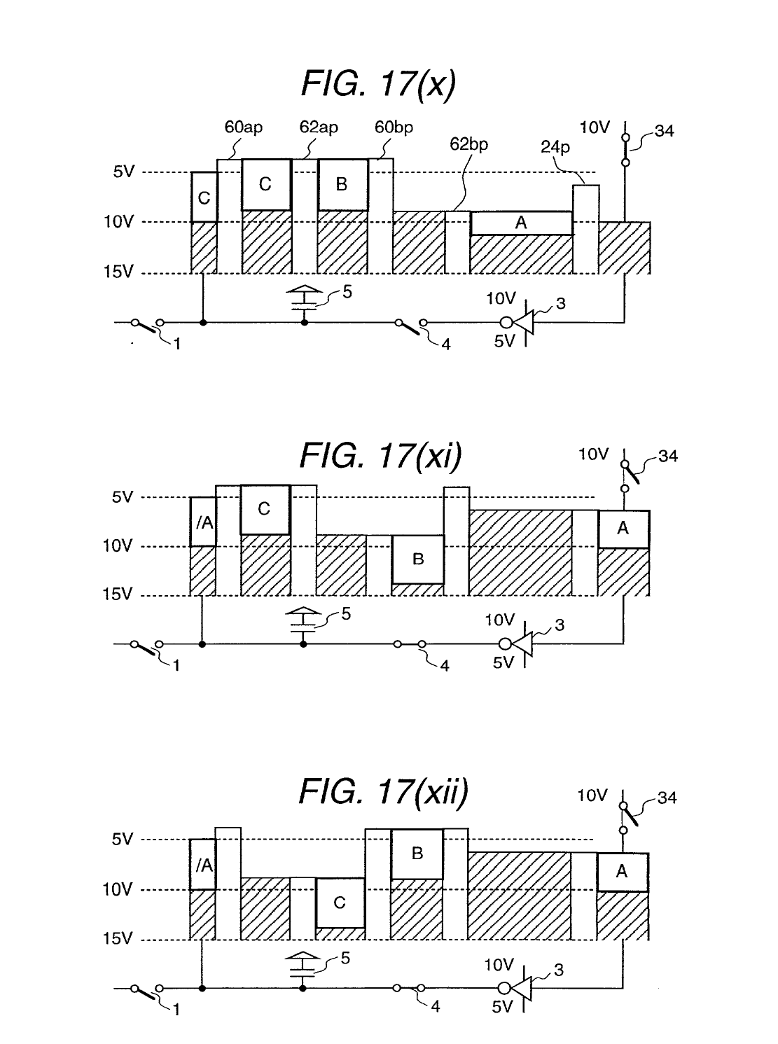

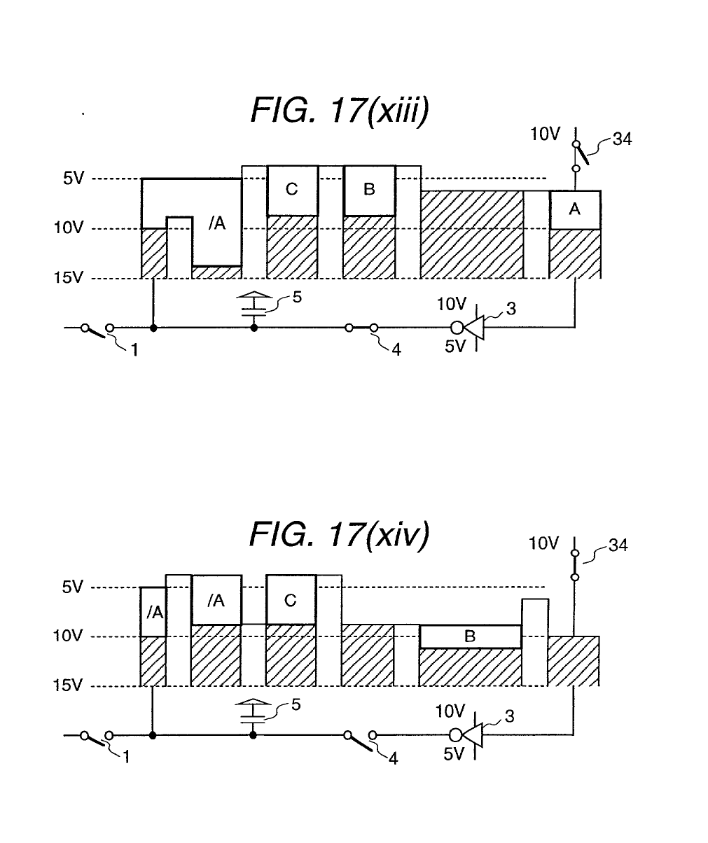

Next, the operations for displaying and rewriting 3-bit digital image data at the pixels are described below by referring to FIGS. 16 and 17.

FIG. 16 shows drive signal waveforms on the first BBD drive line 64, the second BBD drive line 64, the third BBD drive line 65, the forth BBD drive line 66, the reset gate line 35 and the rewrite gate line 31 in the operations of displaying and rewriting the 3-bit digital image data. FIG. 17 shows channel potentials of BBD at the individual points at x) to xiv) shown in FIG. 16. In this figure, the downward direction in the potential means positive values. In the similar manner to FIGS. 14 and 15, the channel potentials at the switches 60a, 62a, 60b, 62b and the output gate 24 are illustrated by the lines 60ap, 62ap, 60bp, 60p and 24p. The symbols A, B and C mean the signal charge representing 3-bit image data at the individual pixel, and the levels of data, “L” and “H”, direct an existence of the signal charges. The symbol, /A, means a reverse signal of A, and if there is a signal charge in A, for example, there is no signal charge in /A. However, for the convenience in explanation, the signal charge /A is also illustrated hypothetically in the physical existence as well as signal charges A, B and C in the figure.

By referring to FIGS. 16 and 17, the drive signal waveforms the changes in the channel potentials in BBD for the individual points at x) to xiv) are described. For all the points from x) to xiv), the gate line 11 and the data input switch 1 controlled by this line are made OFF, and the DC voltage is applied to the signal line 12 or the signal line 12 is grounded in order to prevent the electric power consumption.

x): This case also corresponds to the state that the forth BBD drive line 67 is OFF and the first, second and third BBD drive lines 64, 65 and 66 are ON, and the reset gate line 35 is ON and the write gate line 31 is OFF, which is equivalent to the state in ix) described above. The signal charge C is kept between a couple of potential walls, 60ap and 62ap. The signal charge A is kept between a couple of potential walls, 62bp and 24p. The electric potential at the input terminal of the inverter 3 is fixed to be 10V by the reset switch 34 controlled by the reset gate line 35.

xi): Next, the reset switch 34 is turned off by the reset gate line 35, and then the input terminal of the inverter 3 is floating, and next, as the forth BBD drive line 67 is turned off, the signal charge A is flowing over the potential wall 24p of the output gate 24 and supplied to the input terminal of the inverter 3. As a constant voltage is always applied o the output gate line 25, it should be noted as described above that the level of the potential wall 24p has a constant value and that the value of the capacitance 23c is designed to be approximately twice as large as the value of another BBD capacitances also in this embodiment. As the signal charge A is supplied to the inverter 3, the inverter 3 outputs the inverted signal of A, that is, /A. Its output voltage is 10V when there exists a signal charge A with which the input voltage to the inverter 3 is approximately 6V, and its output voltage is 5V when there does not exit a signal charge A in which the input voltage to the inverter 3 is 10V for the reset state. In the next step, as the rewrite switch 4 is turned on by the rewrite gate line 31, the output voltage of the inverter 3 is applied to the liquid crystal capacitance 5 and the input terminal of BBD 2, and then used for display. As the third BBD drive line 66 is turned on in accordance with the rewrite switch 4 turning on, the signal charge B transfers through the switch 60b to the capacitance 61b, and is kept between a couple of potential walls, 60bp and 62bp. The time for turning on the rewrite switch 4 and the time for turning on the third BBD drive line 66 may be shifted relatively to each other, or may be defined to be exactly identical to each other.

xii): Next, the third BBD drive line 66 is turned off, and then, the second BBD drive line 65 is turned on. The signal charge C transfers through the switch 62a to the capacitance 63a, and is kept between a couple of potential walls, 62ap and 60bp. The signal charge is still kept between a couple of potential walls, 60bp and 62bp.

xiii): The second BBD drive line 65 is turned off, and then, the first BBD drive line 64 is turned on. The signal charge /A is supplied from the inverter 3 to the capacitance 61a through the rewrite switch 4 and the switch 60ap. The signal charge C is still kept between a couple of potential walls 62ap and 60bp, and the signal charge B is still kept between a couple of potential walls, 60bp and 62bp.

xiv): By means that the rewrite switch 4 is turned off by the rewrite gate line 31, the liquid crystal capacitance 5 continues to provide a display output corresponding to the signal charge /A until the rewrite switch 4 is turned on next. The first BBD drive line 64 is turned off in accordance with this operation, the signal charge /A is kept between a couple of potential walls, 60ap and 62ap. The time for turning off the rewrite gate line 31 and the time for turning off the first BBD drive line 64 may be shifted relatively to each other, or may be defined to be exactly identical to each other. Though turning off the first BBD drive line 64 earlier makes more advantageous for stabilizing the input charge amount due to the smaller output impedance of the inverter 3, there is no difference in if the value of the liquid crystal capacitance 5 is large enough. Next, the forth BBD drive line 67 is turned off, and the signal charge B transfers through the switch 62b to the capacitance 63b and kept between a couple of potential walls 62bp and 24p. In accordance with this operation, by means that the reset switch 34 is made ON by the reset gate line 35, the signal charge A is reset and the input to the inverter 3 returns again to 10V. The time for turning off the forth BBD drive line 67 and the time for turning on reset gate line 35 may be shifted relatively to each other, or may be defined to be exactly identical to each other. This state is such a state that the signal charges are shifted forward by 1-bit from the state shown in x).

In this embodiment, by repeating the operations x) to xiv), the output for the 3-bit digital image data can be displayed sequentially by the liquid crystal capacitance 5 as well as the rewrite operation equivalent to the refresh operation of DRAM can be performed simultaneously inside the pixel without using the signal line 12 having a large parasitic capacitance with lower electric power consumption. In this embodiment, every time when the rewrite operation of 3-bit data into the liquid crystal capacitance 5 is completed in the end of a single data loop, the voltage applied to the liquid crystal common electrode 36 is made inverted. With this operation, AC drive of the liquid crystal capacitance 5 is realized as in the similar manner to the embodiment 1.

As for the display operation for 8-level (2 to the power of 3) gray scale images by altering the display periods for three sets of single-bit data so as to increase twice as long as one another, this embodiment equivalent to the embodiment 1, and thus, those operations are not described again in detail here.

As the device structures for the individual switches and BBD, and reflection-type and transmission-type liquid crystal display structures in this embodiment are equivalent to those in the embodiment 1, those are not described again in detail here.

(Embodiment 3)

Next, the embodiment 3 of the present invention is described by referring to FIGS. 18 to 21.

The overall configuration and its operations of this embodiment is basically equivalent to those of the embodiment 1 described by referring to FIG. 1 excluding an inverter ladder to be used as a memory device inside the pixel the structure of BBD (Bucket Brigade Device) 2 and its drive method. Thus, the overall configuration and its operations are not described in detail, but the pixels and BBD featuring this embodiment is mainly described below. Though the individual pixels can store and hold 4-bit digital image data in this embodiment, this will be described later.

FIG. 18 shows an internal structure of the pixel in this embodiment.

DRAM composed of the data input switch 1 and the liquid crystal capacitance 5 is formed in the pixel, and the terminal of the data input switch 1 is connected to the signal line 12. The component 36 is a liquid crystal common electrode. The data hold node of DRAM extends to the first inverter stage composed of the pMOS driver 71a, the nMOS driver 70a and the output switch 72a, the second inverter stage composed of the pMOS driver 71b, the nMOS driver 70b and the output switch 72b, the third inverter stage composed of the pMOS driver 71c, the nMOS driver 70c and the output switch 72c, and the forth inverter stage composed of the pMOS driver 71d, the nMOS driver 70d and the output switch 72d, and is input to the CMOS inverter 3 composed of the pMOS driver 27 and the nMOS driver 26, and then, its output is input again to the data hold node of DRAM through the rewrite switch 4 controlled by the rewrite gate line 31. The individual gates of the individual output switches 72a, 72b, 72c and 72d are connected to the first stage output switch gate line 73, the second stage output switch gate line 74, the third state output switch gate 75 and the forth stage output switch gate line 76, respectively. The high-voltage terminals of the individual CMOS inverters are connected to the 10V electric power line 29, and the low-voltage terminals of the individual CMOS inverters are connected to the 5V electric power line 28. In this structure, a series connection configuration of the inverters from the first stage to the forth stage is designated inverter ladder.

The operation of the pixels in this embodiment is described below.

In this embodiment, in the state that the inverter ladder is not operated, that is, the pixel memory is not used, as ordinary multi-value mode display or analog mode display operations are also equivalent to those in the embodiment, its detail is not described here. In case that the pixel memory is not used, the rewrite switch 4 may be always turned off by the write gate line 31, and thus, an identical lower voltage is preferably applied down to the electric power line 29 and the 5V electric power line 28 in order to reduce the electric power consumption.

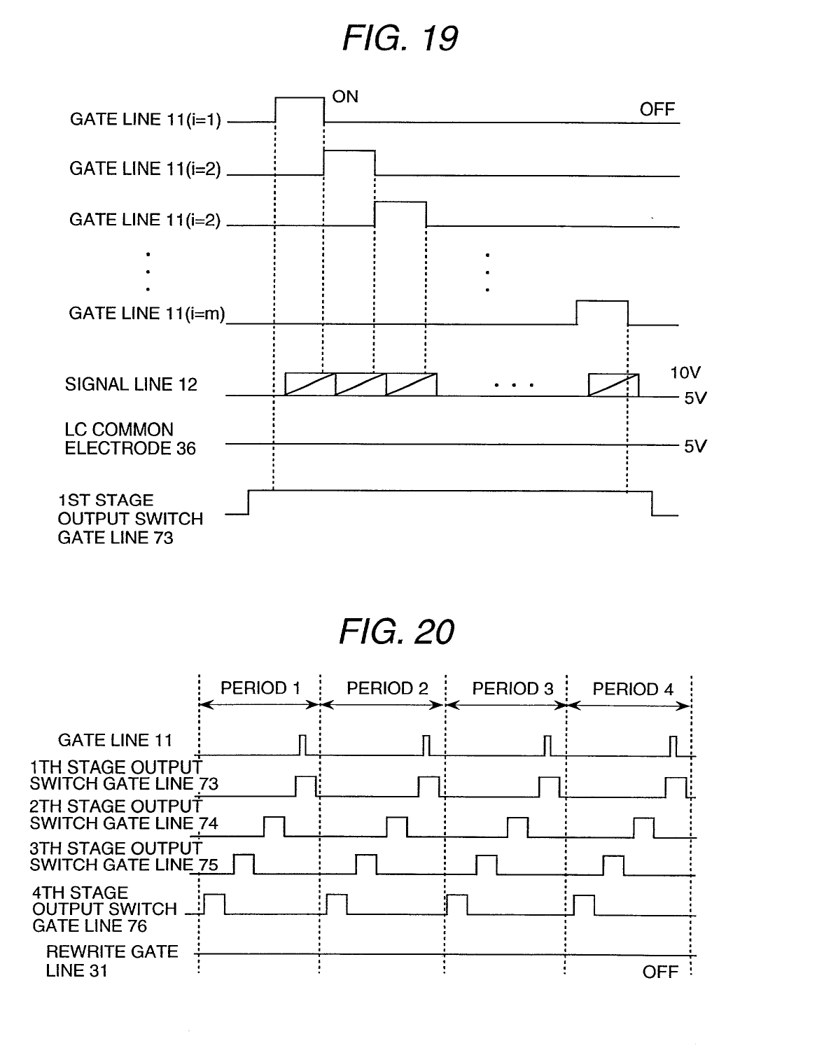

Next, by referring to FIGS. 19 to 20, the operation for writing the 4-bit digital image data into the pixel is described.

FIG. 19 shows drive signal waveforms on the gate line 11, arbitrary signal line 12, the liquid crystal common electrode 36, and the first stage output switch gate line 73 when writing the 1-bit digital image data into the overall pixels, in which the number of pixels is assumed to be m rows. In the individual drawings in this specification, the upward direction in the waveform means an ON state or high voltage, and the downward direction in the waveform means an OFF state or low voltage. For writing 1-bit pixel data, the first stage output switch gate line 73 is turned on at first, and next, the data input switches for the individual rows scanned by the gate line 11 are turned on sequentially. Image data are put into the signal line 12 with a little delay to the drive pulse on the gate line 11. In the end of the above operations, the 1-bit image data for the overall pixels scanned by the gate line is stored in the input capacitance of the second inverter stage composed of the pMOS driver 71b and the nMOS driver 70b through the first inverter stage composed of the pMOS driver 71a and the nMOS driver 70a.

The 1-bit data for the individual pixel changes its polarity between “L” and “H” in this embodiment every time when passing through the inverter, which will not be described in detail below.

Next, the operation of the pixels when writing the 4-bit digital image data is described.

FIG. 20 shows drive signal waveforms on the arbitrary gate line 11, the first stage output switch gate line 73, the second output switch gate line 74, the third stage output switch gate line 75, the forth stage output switch gate line 76 and the rewrite gate line 31. When reading sequentially the 4-bit digital pixel data, the rewrite switch 4 is always made OFF in order to prevent from being rewritten by the inverter ladder.

The operations for the individual periods 1 to 4 shown in FIG. 20 are described below.

Period 1:

At first, the first 1-bit of the digital pixel data is read from the signal line 12 onto the in-pixel inverter ladder. For this operation, the individual output switch gate lines 75 and 74 extended out from the forth stage output switch gate line 76 are turned on and off in advance, and the first stage output switch gate line 73 is turned on and off in the end. The operation of turning on and off the first stage output switch gate line 73 in the end is the operation for writing 1-bit image data into the individual pixels as described by referring to FIG. 19. When repeating the operations of turning on and off the output switch gate lines 76, 75, 74 and 73 at the individual stages, the rest of the output switch gate lines 76, 75, 74 and 73 remain to be OFF as shown in the figure. As described before, the 1-bit pixel data for the overall pixels scanned by the gate line is stored in the input capacitance of the second inverter stage composed of the pMOS driver 71b, the nMOS driver 70b and the output switch 72b. The output switch gate lines 76, 75 and 74 at the individual stages are turned on and off sequentially by starting from the forth stage output switch gate line 76 before turning on and off the first stage output switch gate line, which is aimed for simplification of drive signal waveform formation logic by defining regularly the drive signal waveforms on the individual output switch gate lines 76, 75, 74 and 73. It is apparent that such additional signal drives can be omitted in practice.

Period 2:

Next, as in the similar manner to the previous case, by means that the output switch gate lines 76, 75, 74 and 73 of the individual stages are turned on and off repetitively, the first 1-bit data stored in the input capacitance of the second inverter stage composed of the pMOS driver 71b, the nMOS driver 70b and the output switch 72b is transferred to and stored in the input capacitance of the third inverter stage composed of the pMOS driver 71c, the nMOS driver 70c and the output switch 72c. In the end, by means that the first stage output switch gate line 73 is turned on and off, the second bit of the data is transferred through the data input switch 1 driven by the gate line to the signal line 12, and then stored in the input capacitance of the second inverter stage composed of the pMOS driver 71b, the nMOS driver 70b and the output switch 72b.

Period 3:

Also as in the similar manner to the previous cases, by means that the output switch gate lines 76, 75, 74 and 73 of the individual stages are turned on and off repetitively, the first 1-bit data stored in the input capacitance of the third inverter stage composed of the pMOS driver 71c, the nMOS driver 70c and the output switch 72c is transferred to and stored in the input capacitance of the forth inverter stage composed of the pMOS driver 71d, the nMOS driver 70d and the output switch 72d. The second 1-bit data stored in the input capacitance of the second inverter stage composed of the pMOS driver 71b, the nMOS driver 70b and the output switch 72b is transferred to and stored in the input capacitance of the third inverter stage composed of the pMOS driver 71c, the nMOS driver 70c and the output switch 72c. In the end, by means that the first stage output switch gate line 73 is turned on and off, the third bit of the data is transferred through the data input switch 1 driven by the gate line to the signal line 11, and then stored in the input capacitance of the second inverter stage composed of the pMOS driver 71b, the nMOS driver 70b and the output switch 72b.

Period 4:

Finally, as in the similar manner to the previous cases, , by means that the output switch gate lines 76, 75, 74 and 73 of the individual stages are turned on and off repetitively, the first 1-bit data stored in the input capacitance of the forth inverter stage composed of the pMOS driver 71d, the nMOS driver 70d and the output switch 72d is transferred to and stored in the input capacitance of the inverter 3 composed of the pMOS driver 27 and the nMOS driver 26. The second 1-bit data stored in the input capacitance of the third inverter stage composed of the pMOS driver 71c, the nMOS driver 70c and the output switch 72c is transferred to and stored in the input capacitance of the forth inverter stage composed of the pMOS driver 71d, the nMOS driver 70d and the output switch 72d. The third 1-bit data stored in the input capacitance of the second inverter stage composed of the pMOS driver 71b, the nMOS driver 70b and the output switch 72b is transferred to and stored in the input capacitance of the third inverter stage composed of the pMOS driver 71c, the nMOS driver 70c and the output switch 72c. In the end, the forth bit of the data is transferred through the data input switch 1 driven by the gate line 11 to the signal line 12, and then stored in the input capacitance of the second inverter stage composed of the pMOS driver 71b, the nMOS driver 70b and the output switch 72b. Thus, reading 4-bit digital pixel data is completed in the end of the above described operations. In those operations, the individual 1-bit data is kept in the input capacitance of the individual inverter. By means that an additional capacitance is formed at the input terminal of the individual inverter, if required, the data hold characteristic at the pixel can be made stable by trading off the increase in the dimension occupied by the circuit.

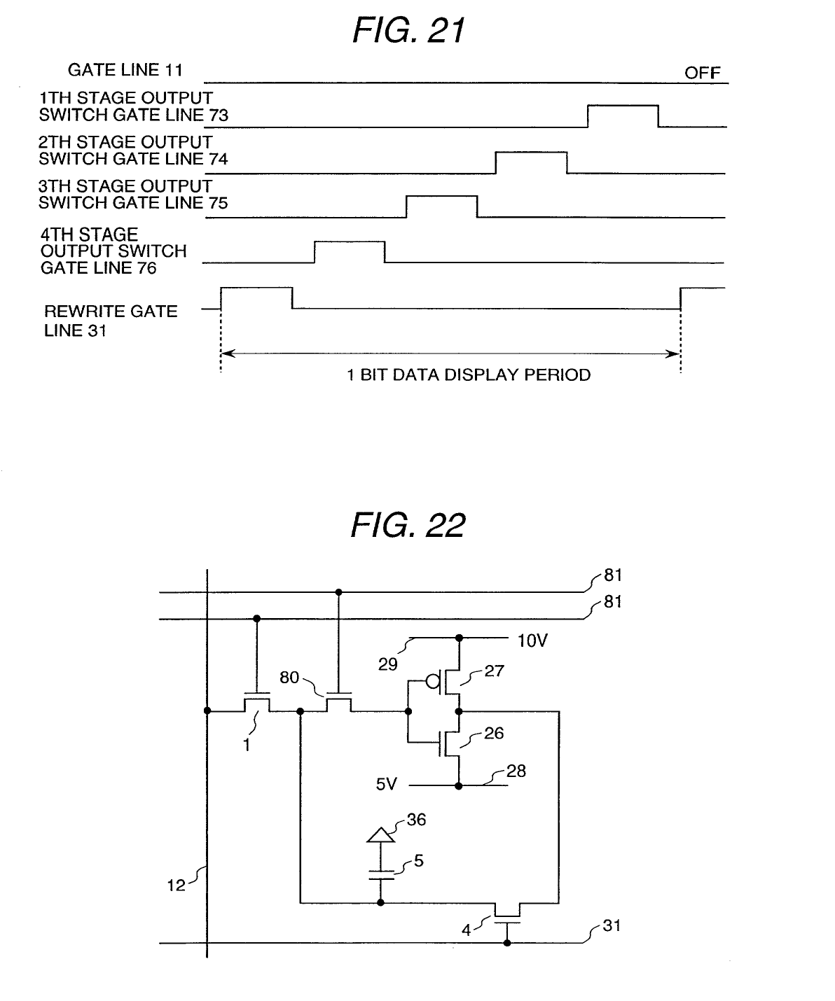

Next, the operations for displaying and rewriting 4-bit digital image data at the pixels are described below by referring to FIG. 21.

FIG. 21 shows drive signal waveforms on the arbitrary gate line 11, arbitrary signal line 12, the first stage output switch gate line 73, the second stage output switch gate line 74, the third stage output switch gate line 75, the forth stage output switch gate line 76 and the rewrite gate line 31 when displaying and rewriting the 4-bit digital image data at the pixel. When displaying and rewriting 44-bit digital image data, the gate line 11 and the data input switch 1 controlled by this are made OFF, and the DC voltage is applied to the signal line 12 or the signal line 12 is grounded in order to prevent the electric power consumption.

At first, the rewrite switch 4 is turned on and off by the rewrite gate line 31. With this operation, the first 1-bit data stored in the input capacitance of the inverter 3 composed of the pMOS driver 27 and the nMOS driver 26 is transferred to the liquid crystal capacitance 5, and stored and displayed. At the same time, this data is also stored in the input capacitance of the first inverter stage composed of the pMOS driver 71a, the nMOS driver 70a and the output switch 72a. It should be noted that the first 1-bit data is reversed with respect to the data input at first when this data is input again into the input capacitance of the first inverter stage. This means that the polarity of the data in terms of “L” and “H” changes. This is due to an existence of odd number (5 stages) of inverters in the data rewrite loop of the memory.

Next, by means of the forth stage output switch gate line 76 turns on and off, the second bit of the data stored in the input capacitance of the forth inverter stage composed of the pMOS driver 71d, the nMOS driver 70d and the output switch 72d is transferred to and stored in the input capacitance of the inverter 3 composed of the pMOS driver 27 and the nMOS driver 26.

Next, by means of the third stage output switch gate line 75 turns on and off, the third bit of the data stored in the input capacitance of the third inverter stage composed of the pMOS driver 71c, the nMOS driver 70c and the output switch 72c is transferred to and stored in the input capacitance of the forth inverter stage composed of the pMOS driver 71d, the nMOS driver 70d and the output switch 72d.

Next, by means of the second stage output switch gate line 74 turns on and off, the forth bit of the data stored in the input capacitance of the second inverter stage composed of the pMOS driver 71b, the nMOS driver 70b and the output switch 72b is transferred to and stored in the input capacitance of the third inverter stage composed of the pMOS driver 71c, the nMOS driver 70c and the output switch 72c.

Finally, by means of the first stage output switch gate line 73 turns on and off, the first inversed bit of the data stored in the input capacitance of the first inverter stage composed of the pMOS driver 71, the nMOS driver 70a and the output switch 72a is transferred again to and stored again in the input capacitance of the second inverter stage composed of the pMOS driver 71b, the nMOS driver 70b and the output switch 72b.

In this embodiment, by repeating the above operations, the output for the 4-bit digital pixel data can be displayed sequentially as well as the rewrite operation equivalent to the refresh operation of DRAM can be performed simultaneously inside the pixel without using the signal line 12 having a large parasitic capacitance with lower electric power consumption. In this embodiment, every time when the rewrite operation of 4-bit data into the liquid crystal capacitance 5 is completed in the end of a single data loop, the voltage applied to the liquid crystal common electrode 36 is made inverted. With this operation, AC drive of the liquid crystal capacitance 5 is realized as described before in referring to FIG. 1.

This embodiment also has the same architecture as the embodiment 1 including that 16-level (2 to the power of 4) gray scale image display can be established by altering the display periods for four sets of single-bit data so as to be twice as long as one another, and that reflection-type and transmission-type liquid crystal displays are used similarly, which is not described again here.

Though the individual transistors in this embodiment use poly-Si TFT as in the embodiment 1, as this embodiment does not require BBD, there is such an advantage that the impurity doping process for forming capacitances can be omitted.

Though this embodiment assumes 4-bit image data to be used for display, the structure in this embodiment can be applied to another bit length for the image data. In case of applying this structure to another bit length other than 4-bit image data, it is required to add or remove appropriately an inverter circuit for adjusting the inversion of data. For example, if an inversion drive is not considered also in this embodiment, the inverter circuit composed of the pMOS driver 71a and the nMOS driver 70a can be omitted, and thus, the inverter circuit having the individual pixel can be designed to be configured in three stages if 3-bit image data is processed.

(Embodiment 4)

By referring to FIGS. 22 to 24, the embodiment 4 in the present invention is described below.

This embodiment is equivalent to the configuration in the embodiment 3 in which the data length of the image data stored in the pixel is formed as 1-bit. The overall structure and its operations are identical to those in the embodiment 1 described by referring to FIG. 1, excluding that switches are used as memory devices instead of BBD (Bucket Brigate Device) 2. Thus, the overall structure and its operations are not described here, but the pixel featuring this embodiment is mainly described below.

FIG. 22 shows an internal structure of the pixel in this embodiment.

DRAM composed of the data input switch 1 and the liquid crystal capacitance 5 is formed in the pixel, and the terminal of the data input switch 1 is connected to the signal line 12. The component 36 is a liquid crystal common electrode. The data hold node of DRAM is input through the amplifier input switch 80 to the CMOS inverter 3 composed of the pMOS driver 27 and the NMOS driver 26, and its output is input again to the data hold node of DRAM through the rewrite switch 4. The gate of the amplifier input switch 80 is connected to the amplifier input switch gate line 81. The high-voltage terminals of the individual CMOS inverters are connected to the 10V electric power line 29, and the low-voltage terminals of the individual CMOS inverters are connected to the 5V electric power line 28.

The operation of the pixels in this embodiment is described below.

In this embodiment, in the state that the inverter 3 is not operated, that is, the pixel memory is not used, as ordinary multi-value mode display or analog mode display operations are also equivalent to those in the embodiment, its detail is not described here. In case that the pixel memory is not used, the rewrite switch 4 may be always turned off by the write gate line 31, and thus, an identical lower voltage is preferably applied down to the electric power line 29 and the 5V electric power line 28 in order to reduce the electric power consumption.

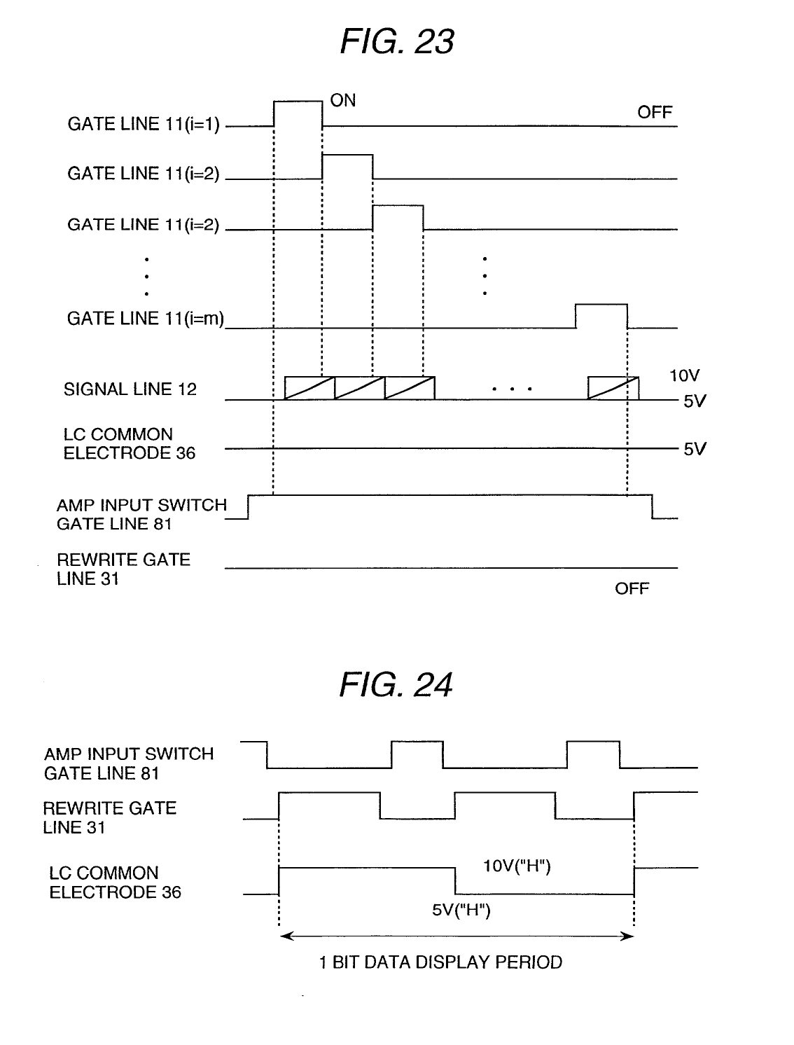

Next, by referring to FIG. 23, the (refresh) operation for writing the 1-bit digital image data into the pixel is described.

FIG. 23 shows drive signal waveforms on the gate line 11, arbitrary signal line 12, the liquid crystal common electrode 36, and the amplifier input switch gate line 81 when writing the 1-bit digital image data into the overall pixels, in which the number of pixels is assumed to be m rows. In the individual drawings in this specification, the upward direction in the waveform means an ON state or high voltage, and the downward direction in the waveform means an OFF state or low voltage. For writing 1-bit pixel data, the first stage output switch gate line 73 is turned on at first, and next, the data input switches for the individual rows scanned by the gate line 11 are turned on sequentially. Image data are put into the signal line 12 with a little delay to the drive pulse on the gate line 11. In the end of the above operations, the 1-bit image data for the overall pixels scanned by the gate line is input through the amplifier input switch 80 to the CMOS inverter 3 composed of the pMOS driver 27 and the nMOS driver 26, and stored into its input capacitance. The liquid crystal common electrode 36 is kept in a constant voltage, and the rewrite gate line 31 makes the rewrite switch 4 kept turned off and thus, disable the rewrite operation by the CMOS inverter 3.

The 1-bit data for the individual pixel changes its polarity between “L” and “H” in this embodiment every time when passing through the inverter, which will not be described in detail below. The 1-bit image data is kept in the input capacitance of the CMOS inverter 3, in other words, the amplifier input switch 80 and the input capacitance of the CMOS inverter 3 form another DRAM. By means of forming additional capacitances at the input terminals of the individual inverters, the data hold characteristic at the pixel can be made stable by trading off the increase in the dimension occupied by the circuit.

Next, the operations for displaying and rewriting 1-bit digital image data at the pixels are described below by referring to FIG. 24.

FIG. 24 shows drive signal waveforms on the amplifier input switch gate line 81, the rewrite gate line 31 and the liquid crystal common electrode 36 when displaying and rewriting the 1-bit digital image data at the pixel. When displaying and rewriting the 1-bit digital image data, the gate line 11 and the data input switch 1 controlled by this are made OFF, and the DC voltage is applied to the signal line 12 or the signal line 12 is grounded in order to prevent the electric power consumption.

At first, the amplifier input switch 80 is made OFF by the amplifier input switch gate line 81, and this signal waveform is identical to the signal waveform when the data is written in to the pixel as described by revering to FIG. 23. Next, the rewrite switch 4 is turned on and off by the rewrite gate line 31, and in accordance with this operation, the polarity of the liquid crystal common electrode 36 changes its value from “L” to “H”. The 1-bit data stored in the input capacitance of the inverter 3 composed of the pMOS driver 27 and the nMOS driver 26 is transferred to the liquid crystal capacitance 5 and stored there, and then, used for display. It should be noted here that the 1-bit data at this point is an inversion of the data primarily input into the pixel, that is, its polarity “L” or “H” is altered.

Next, by means that the amplifier input switch gate line 81 turns on and off, the 1-bit inverted pixel data stored in the liquid crystal capacitance 5 is transferred again to and stored in the input capacitance of the inverter 3 composed of the pMOS driver 27 and the nMOS driver 26.

Next, the rewrite switch 4 is turned on and off by the rewrite gate line 31, and in accordance with this operation, the polarity of the liquid crystal common electrode 36 changes to “L” level. Then, the 1-bit inverted pixel data stored in the liquid crystal capacitance 5 is transferred again to and stored in the input capacitance of the inverter 3 composed of the pMOS driver 27 and the nMOS driver 26, and used for display. It should be noted again here that the 1-bit data at this point is identical to the data primarily input into the pixel, that is, its polarity “L” or “H” returns to be original. As the liquid crystal common electrode 36 is inverted again here, it can be recognized that AC voltage drive of the liquid crystal is established.

After that, by means that the amplifier input switch gate line 81 turns on and off, the 1-bit pixel data stored in the liquid crystal capacitance 5 is transferred to and stored in the input capacitance of the inverter 3 composed of the pMOS driver 27 and the nMOS driver 26.

In this embodiment, by repeating the above operations, the rewrite operation equivalent to DRAM refresh operation along with the inversion and display operation for the output corresponding to the 1-bit image data can be performed without using the signal line 12 having a large parasitic capacitance with lower electric power consumption.

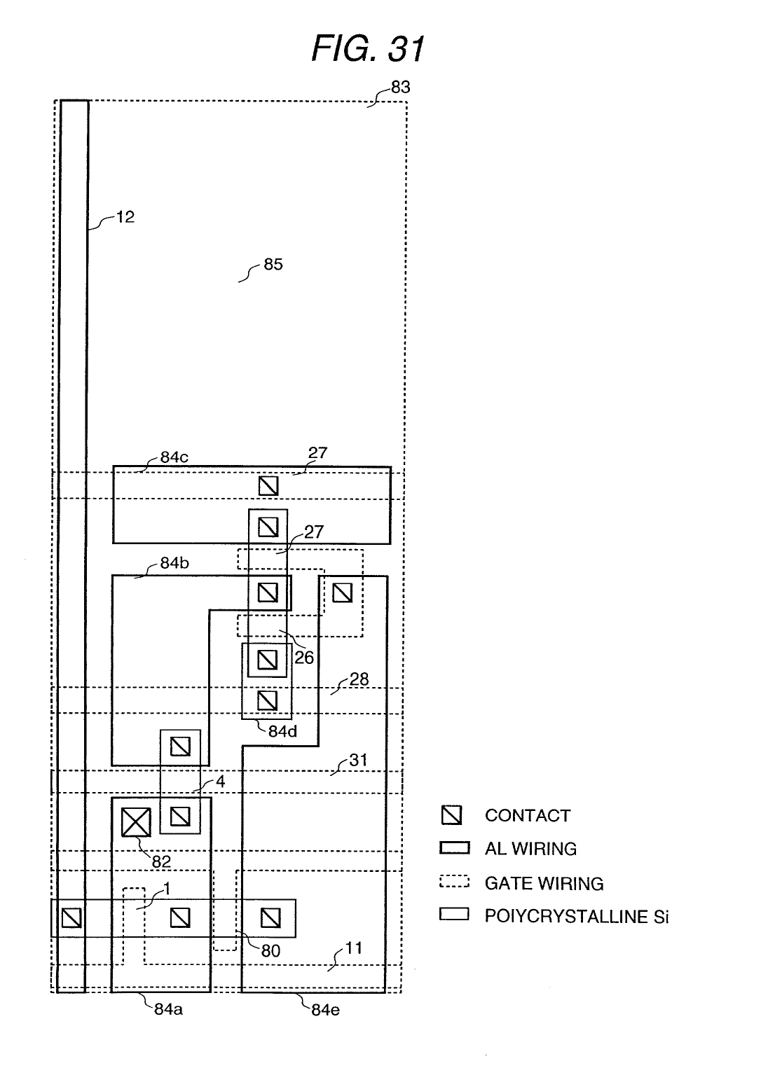

In this embodiment, such a partial transmission-type liquid crystal display structure as both of reflection-type and transmission-type image displays can be available is employed. This structure will be describe by referring to FIG. 31 below.

FIG. 31 illustrates a plan view of the pixel 83 in this embodiment, showing a layout including polycrystalline Si islands, gate wirings, Al wiring layers and contact holes.

The signal line 12 wired with Al is input to the Al reflecting electrode 84e through the data input switch 1 with agate electrode formed by the gate line 11 and the amplifier input switch 80 with a gate electrode formed by the amplifier input switch gate line 81. The Al reflecting electrode 84e is connected to the gate electrodes of the pMOS driver 27 and the nMOS driver 26, and the pMOS driver 27 and the nMOS driver 26 are connected to the 10V electric power line 29 and the 5V electric power line 28, each composed of the gate wiring layers, respectively through the Al reflecting electrode 84c and the al reflecting electrode 84d. The output of the CMOS inverter composed of the pMOS driver 27 and the nMOS driver 26 is input through the Al reflecting electrode 84b to the rewrite switch 4 having a gate electrode formed by the rewrite gate line 31a, and its output is coupled to the output of the data input switch 1 through the Al reflecting electrode 84a. The Al reflecting electrode 84a has an ITO contact 82, which is connected to the liquid crystal electrode 5 through the ITO electrode (not shown in the figure) covering the overall pixel 83.

The electrical operation of the pixel is so described as referring to FIG. 22, and thus, the optical structure of the pixel is now described below. As the Al reflecting electrodes 84a, b, c, d and e covering the pixel 83 have a role for reflecting the incident light from outside, this embodiment can provide a reflection-type liquid crystal display established only with the external light. The region 85 which excludes the Al reflecting electrodes 84a, b, c, d and e and the signal line 12 is an open port for making the backlight formed behind the liquid crystal display panel transmit through the whole area of the panel. In this embodiment, as the scale of the circuit for adding the memory function to the pixel is small, there is such an advantage that an enough size of the open port can be obtained for providing such transmission-type liquid crystal display. In this embodiment, the size of the pixel is 252 m×84 m, which establishes 30% or more transmission aperture even if using a layout rule using minimum dimension of 84 m.

Though the individual transistors in this embodiment use poly-Si TFT as in the embodiment 1, as this embodiment does not require BBD, there is such an advantage that the impurity doping process for forming capacitances can be omitted.

Though the amplifier input switch 80 is installed between the inverter 3 and the data input switch 1 in this embodiment, the amplifier input switch 80 may be installed between the liquid crystal capacitance 5 and the data input switch 1. This modification means that the position of the node to which the data is input is changed for a designated data loop. It is allowed to apply the same kind of modification in the circuit structure as described above and various kind of modification in the circuit structure also to other embodiments.

Though the period of time during which the rewrite switch 4 is kept ON is defined to be longer than the period of time during which the amplifier input switch 80 is kept ON in this embodiment, this period of time can be modified accordingly. For example, it is preferable in view of design to determine the period of time during which the individual switch is made ON by comparing the time constant for holding charge in the liquid crystal capacitance 5 and the time constant for holding charge in the input capacitance of the inverter 3. As the frame frequency reduces, flickers become outstanding due to AC drive of the liquid crystal also in this embodiment as seen in other embodiments. However, as the reduction in the frame frequency may reduce the electric power consumption, an optimum frame frequency should be properly determined for the application or its usage.

(Embodiment 5)

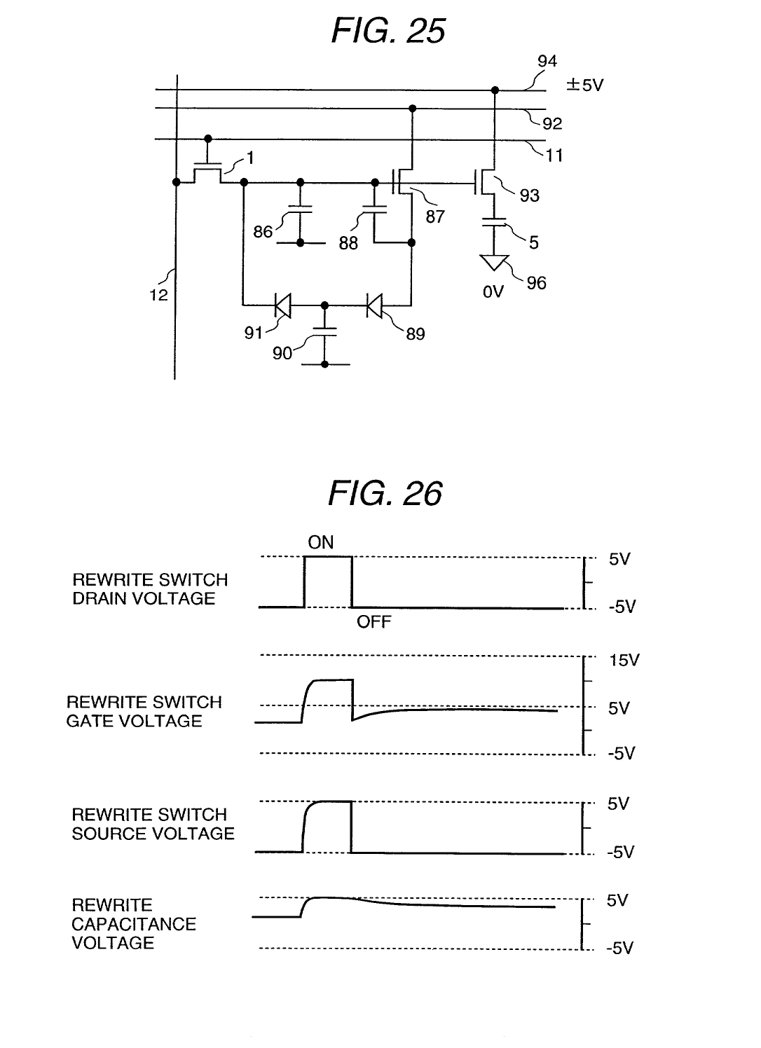

By referring to FIGS. 25 and 26, the embodiment 5 in the present invention is described below.

The basic structure and its operation in this embodiment is similar to the structure and its operation in the prior art described by referring to FIG. 30. The specific difference in this embodiment from the prior art described by referring to FIG. 30 is that the individual pixel has such a structure that the individual pixel can refresh the 1-bit image data the pixel without using the signal line. Thus, the overall structure and its operations are not described here, but the pixel featuring this embodiment is mainly described below.

FIG. 25 shows an internal structure of the pixel in this embodiment.

DRAM composed of the data input switch 1 and the liquid crystal capacitance 5 is formed in the pixel, and the terminal of the data input switch 1 is connected to the signal line 12. This data node is connected to the gate of the pixel drive switch 93, and the one terminal of the liquid crystal capacitance 5 is connected to the opposed electrode 96, and the other terminal is connected to the common electrode 94 through the pixel drive switch 93. This structure is identical to that in the prior art described by referring to FIG. 30. This embodiment has the following structure in addition. The data node described above is further connected to the gate of the rewrite switch 8, and the drain of the rewrite switch 87 is connected to the rewrite switch drain line 92. The source of the rewrite switch 87 is fed back to the data node again via the first rewrite diode 89, the rewrite capacitance 90 and the second rewrite diode 91. A bootstrap capacitance 88 is installed between the data node and the source of the rewrite switch 87.

Now, the operation in the prior art is described below. By means that the gate line 11 opens and closes the data input switch 1, the 1-bit image data on the signal line 12 is input to DRAM composed of the data input switch 1 and the hold capacitance 86 corresponding to a designated pixel row. The pixel drive switch 93 is hold to be ON or OFF in responsive to the image data written in DRAM. As AC voltage is applied to the opposed electrode 96, and a designated voltage is applied to the common electrode line 94, AC voltage is applied to the liquid crystal capacitance 5 in case that the pixel drive switch 93 is turned on, otherwise no voltage is always applied to the liquid crystal capacitance 5 incase that the pixel drive switch 93 is turned off. According to this operation, even if the scanning operation of the gate line 11 and the data output operation to the signal line 12 are interrupted, the liquid crystal display panel can continue to display the 1-bit image data until the data in DRAM is lost due to the leak current. Those operations so far are the same as the operations in the prior art described by referring to FIG. 30.

In this embodiment, the following operations makes it possible for the individual pixel to refresh the 1-bit image data within the pixel without using the signal line Those operations will be described below by referring to FIG. 26.

FIG. 26 shows voltage signal waveforms on the drain, gate and source of the rewrite switch 87 and a voltage signal waveform on the terminal of the rewrite capacitance 90 to which the rewrite diode is connected in the refresh operation described above. In the refresh operation, a positive pulse is applied to the rewrite switch drain line 92. This voltage is applied straightforwardly to the drain of the rewrite switch 87, in which the gate voltage of the rewrite switch 87 is −5V if the stored data in DRAM is “L”, and thus, the rewire switch 87 never turns on and the voltage in the pixel does not change (not shown in the figure). However, the stored data in DRAM is “H”, the gate voltage f the rewrite switch 87 is +5V. In practice, though it is assumed that the gate voltage is reduced down to approximately +2V due to the leak in DRAM, the rewrite switch 87 is turned on and the source voltage rises up to 5V like the drain voltage even in this case as shown in the figure. This is because the gate voltage rises up approximately to 10V due to the bootstrap capacitance 88 formed between the source and the gate. At this time, the voltage of the rewrite capacitance 90 shown in the figure rises up approximately to 5V. This is because the first rewrite diode 89 is connected in the forward direction between the rewrite capacitance 90 and the source of the rewrite switch 87, in which the rewrite capacitance 90 is charged up until its voltage becomes almost 5V. At this time, the backward voltage is applied to the second rewrite diode 9, and the charge leakage from the memory node of DRAM to the second rewrite diode 91 can be negligible.

After that, the voltage of the pulse on the rewrite switch drain line 92 returns to be −5V. This voltage is applied straightforwardly to the drain of the rewrite switch 87, in which the gate voltage of the rewrite switch 87 is −5V if the stored data in DRAM is “L”, and thus, the rewire switch 87 never turns on and the voltage in the pixel does not change (not shown in the figure). However, in case that the data stored in DRAM is “H” as described above, the gate voltage of the rewrite switch 87 turns back to −5V and the source voltage turn back to the drain voltage, −5V as the gate is ON. The voltage of the rewrite capacitance 90 shown in the figure rises up approximately to 5V, and its charge flows into the gate terminal of the rewrite switch 87 as the memory node of DRAM. This is because the second rewrite diode 91 connected between the rewrite capacitance 90 charged up to 5V and the gate of the rewrite switch 87 is biased forwardly with the voltage of the rewrite capacitance 90, 5V, and the gate voltage of the rewrite switch 87, +2V, and this charge injection continues until the voltage of the rewrite capacitance 90 and the voltage of the gate of the rewrite switch 87 are identical to each other. This charge injection occurs consequently when the gate voltage of the rewrite switch 87 with its level being “H” is 5V or less, which is equivalent to the refresh operation of DRAM in this embodiment. At this time, a backward voltage is applied to the first rewrite diode 89, and the charge leakage from the rewrite capacitance 90 to the rewrite switch drain line 92 can be negligible. In this embodiment, by applying a pulsed voltage to the rewrite switch drain line 92 at a designated timing, the rewrite operation equivalent to DRAM refresh operation can be performed without using the signal line 12 having a large parasitic capacitance with lower electric power consumption.

As the reflection-type and transmission-type liquid crystal display structures in this embodiment are equivalent to those in the embodiment 1, those are not described again in detail here.

Though the rewrite switch drain line 92 is commonly connected to all the pixels in this embodiment, by means that this line is shared by the line or column of pixels, the peak electric power consumption for the refresh operation can be reduced by trading off the increases in the complexity of the drive circuit.

The individual transistor in this embodiment is formed by poly-Si TFT similarly as in the embodiment 1, in which the first rewrite diode 89 and the second rewrite diode 91 are formed by poly-Si with n+/i/p+ lateral conjunction in order to avoid an unnecessary increase in the number of fabrication processes. In this embodiment, though diode devices are used in order to transfer the signal charge for rewrite operation in one direction, those devices may be formed by TFT switches driven with adequate drive signal pulses. In this alternative case, though the complexity in the pixel increases because designated drive signals is required to be applied to those TFT switches, the fabrication process can be simplified by forming pixels only with TFT alone.

In this embodiment, how to apply the grounded voltage to the counter electrodes for the hold capacitance 86 and the rewrite capacitance 90 is not described explicitly. This is because this method of applying the grounded voltage is not essential to the spirit of the present invention, but it is obvious to able to imply several implementations for this method, including a common wiring used for applying the grounded voltage, a usage of gate lines 11 at the adjacent pixel rows and so forth.

(Embodiment 6)

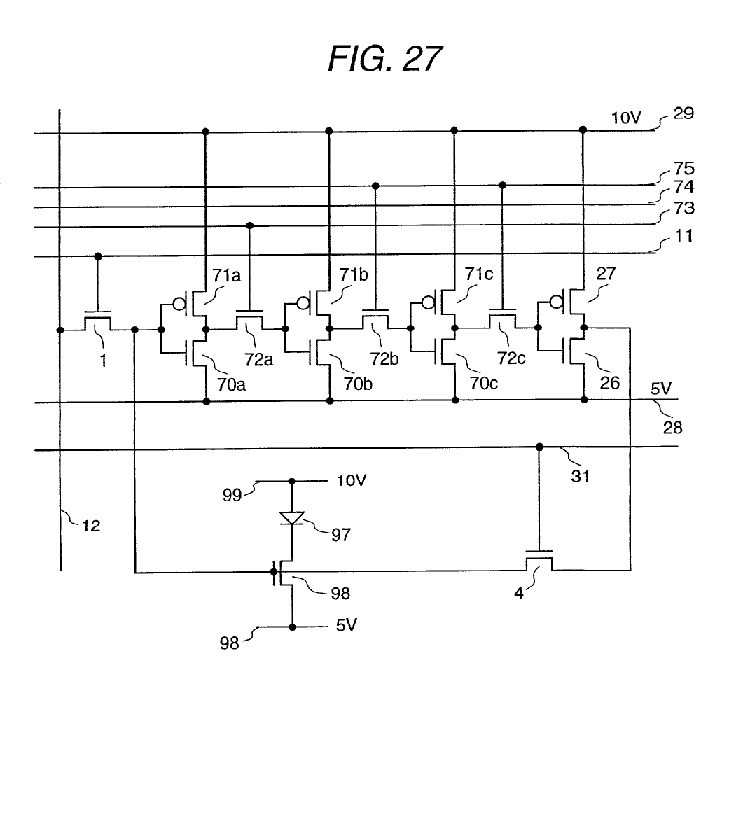

By referring to FIG. 27, the embodiment 6 in the present invention is described below.

The structure and its operation in this embodiment are almost identical to those in the embodiment 3 described by referring to FIGS. 18 to 2, excluding such features that the number of stages in the inverter ladder is one less than the number of stages in the embodiment 3, the length of the pixel data to be stored is 3-bit, and that the luminescence drive switch 96, the luminescence device 97 and the low voltage electric power line 98 and the high voltage electric power line 99 for supplying luminescence current to this device are installed instead of the liquid crystal capacitance 5 and the liquid crystal common electrode 36. Thus, the overall structure and its operations are not described here, but the pixel is described by focusing the luminescence device 97 featuring this embodiment.

FIG. 27 shows an internal block diagram of the pixel in this embodiment.

The pixel has the data input switch 1 and DRAM composed of the gate capacitance of the luminescence drive switch 96, and the terminal of the data input switch 1 is connected to the signal line 12. The data hold node of DRAM extends to the first inverter stage composed of the pMOS driver 71a, the nMOS driver 70a and the output switch 72a, the second inverter stage composed of the pMOS driver 71b, the nMOS driver 70b and the output switch 72b, and the third inverter stage composed of the pMOS driver 71c, the nMOS driver 70c, and is input to the CMOS inverter 3 composed of the pMOS driver 27 and the nMOS driver 26, and then, its output is input again to the data hold node of DRAM through the rewrite switch 4 driven by the rewrite gate line 31. The individual gates of the output switches 72a, 72b and 72c are connected to the first stage output switch gate line 73, the second stage output switch gate line 74 and the third stage output switch gate line 75, respectively. The high voltage terminals of the individual CMOS inverters are connected to the 10V electric power line 29 and the low voltage terminals of the individual CMOS inverters are connected to the 5V electric power line 28. And furthermore, in this embodiment, the source of the luminescence drive switch 96 is connected to the low voltage electric power line 98, and the drain of the luminescence drive switch 96 is connected through the luminescence device 97 to the high voltage electric power line 99. As the voltage 5V is applied to the low voltage electric power line 98 and the voltage 10V is applied to the high voltage electric power line 99, those electric power lines are connected to the 5V electric power line 28 and the 10V electric power line 29, respectively, which connections are not shown in the figure for simplification.

The operations of the pixel in this embodiment is described below.

Also in this embodiment, in the state that the inverter ladder is made not operated, that is, the pixel memory is not used, ordinary multi-valued display or analog display operations are the same as those in the embodiment 3, which will not be explained again here. As luminescence devices 97 are used for display in this embodiment, there is no need for AC drive of the data as used in the embodiment 3.

As for writing, displaying and rewriting operations of 3-bit digital image data for the pixel, those operations are identical to those in the embodiment 3 excluding that the data length is 3-bit.

In this embodiment, when the rewrite switch 4 is turned on and off by the rewrite gate linen 31, 1-bit data stored in the input capacitance of the inverter 3 composed of the pMOS driver 27 and the nMOS driver 26 is transferred to and stored in the gate capacitance of the luminescence drive switch 96 and the input capacitance of the first inverter stage. It should be noted that, as the number of the inverters on the data loop is even (4) in this embodiment, the polarity of this 1-bit data is not inverted and its value “L” or “H” is not changed even if the 1-bit data is input again to the input capacitance of the first inverter stage. This is because, as this embodiment uses luminescence devices 97 for display, it is not required to perform such AC drive as used in the embodiment 3.

When 1-bit data is input to the gate, the luminescence drive switch 96 turns on and off the switch in responsive to the value of the data, “L” or “H”. If the switch is OFF, any current flows into the luminescence device 97 and thus there is no light emitted, but a designated amount of current flows into the luminescence device 97 and the device emits light. In order to optimize the luminance of the luminescence device 97, there are several alternative methods including an optimization of the structure of the luminescence device 97 itself, an adjustment of voltages on the electric power lines 98 and 99 which are separated from the 5V electric power line 28 and the 10V electric power line 29, respectively, and an formation of a designated resistance with poly-Si and like between the luminescence drive switch 96 and the low voltage electric power line 98. Those three methods provide such advantages that the structure of the pixel can be simplified, an fine adjustment of the applied voltage can be available after installation, and that a high voltage source can be embedded inside the pixel without modifying the manufacturing process, respectively.

Though Organic Light Emitting Diode (OLED) is used for the luminescence device 97 in this embodiment, it is allowed to use another two-terminal luminescence device such as Inorganic Light Emitting Diode, Electro Luminescence Device and so on. Though the voltage required to emit lights depends on the individual luminescence devices, this voltage difference can be controlled by varying the applied voltage on the low voltage electric power line 98 and the high voltage electric power line 99 for the individual 5V power line 28 and 10V power line 29, respectively.

This embodiment provides such an advantage that, by forming a luminescence device 97 inside the pixel, images can be displayed with self-luminescence devices in low electric power consumption without using the signal line 12 even if additional lights.

This embodiment also has the same architecture as the embodiment 1 including that 8-level (2 to the power of 3) gray scale image display can be established by altering the display periods for three sets of single-bit data so as to be twice as long as one another, which is not described again here.

Though this embodiment assumes 3-bit image data to be used for display, the structure in this embodiment can be applied to another bit length for the image data. In case of applying this structure to another bit length other than 3-bit image data, it is required to add or remove appropriately an inverter circuit for adjusting the inversion of data or to use an amplifier which does not cause data inversion in order to invert the data after a single data loop.

(Embodiment 7)

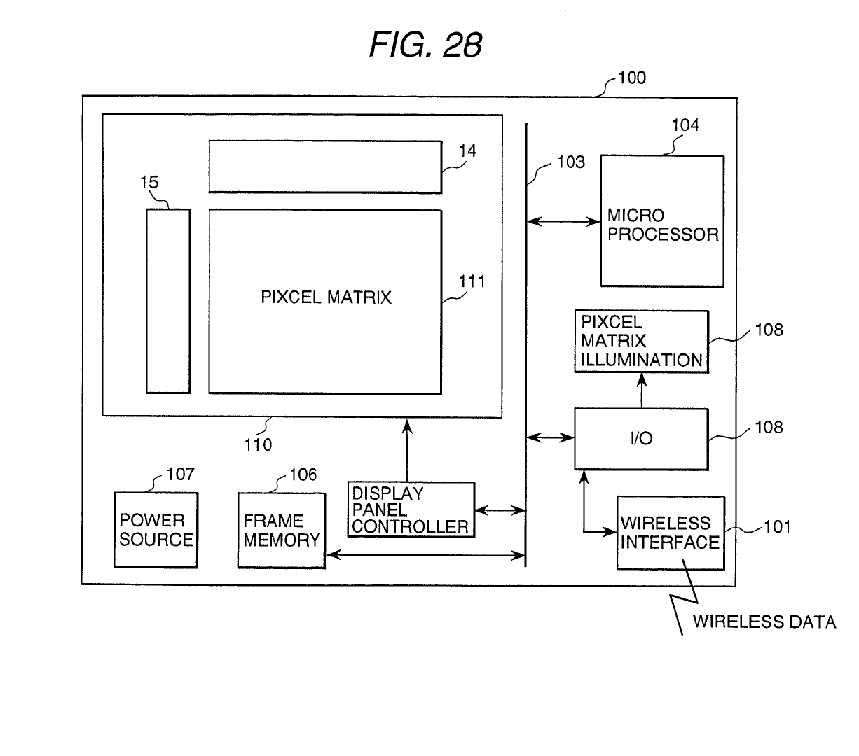

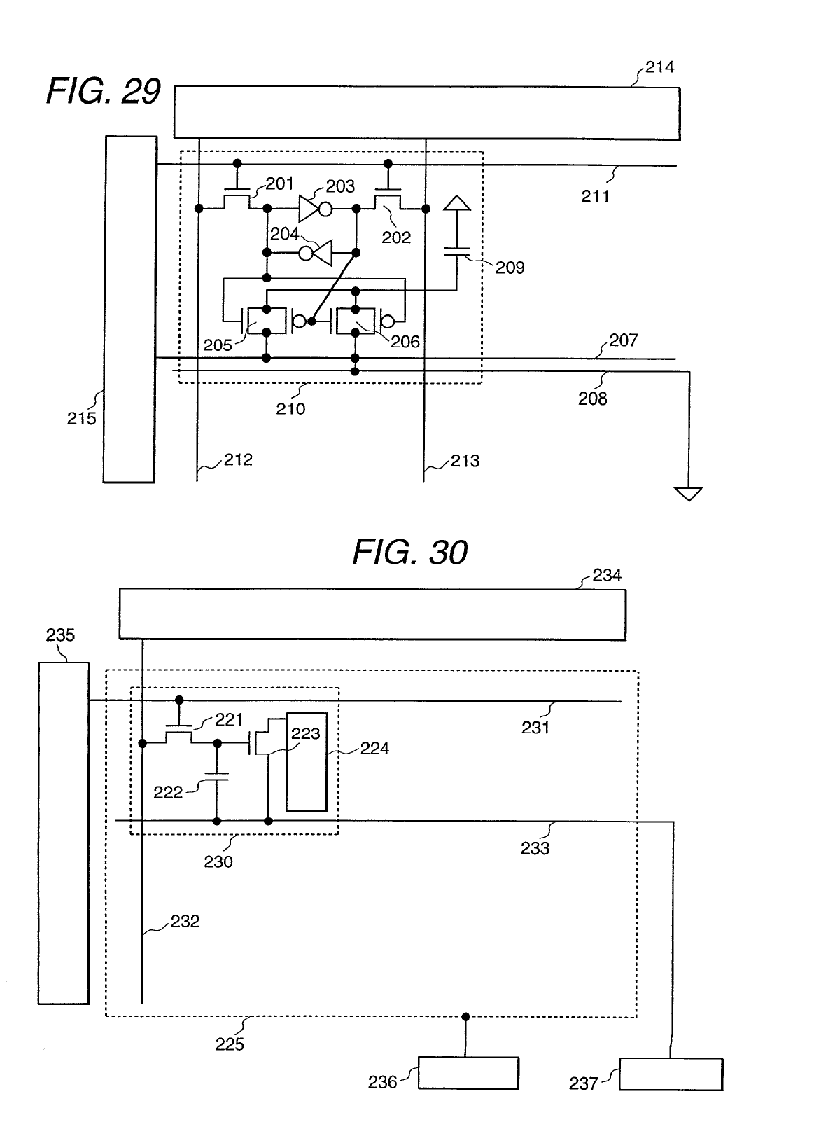

By referring to FIG. 28, the embodiment 7 in the present invention is described below.

FIG. 28 is a block diagram of the image display terminal (PDA: Personal Digital Assistants) of the embodiment 7.

The compressed image data as wireless data coded in the format based on the BlueTooth specification are input to the wireless interface (I/F) circuit 101 from outside, and the output of the wireless I/F circuit 101 is connected through the I/O (Input Output) circuit 102 to the data bass 103. What connected to the data bass 103 include the microprocessor 104, the display panel controller 105, and the frame memory and so on. The output of the display panel controller 105 is coupled to the reflection/transmission display poly-Si TFT liquid crystal display panel 110, and the reflection/transmission display poly-Si TFT liquid crystal display panel 110 has the pixel matrix 111, the gate line drive circuit 15, and the signal line drive circuit 14 and so on. The image display terminal 100 has the electric power source 107 and the pixel matrix backlight 108, and the pixel matrix backlight 108 is controlled by the I/O circuit 102. As the reflection/transmission display poly-Si TFT liquid crystal display panel 110 has an identical structure and function to that in the embodiment 1 described above, its internal structure and function are not described here.

The operation in the embodiment 7 is described below. At first, the wireless I/F circuit 101 accepts the compressed image data from outside in responsive to the instruction, and the image data are transferred through the I/O circuit to the microprocessor 104 and the frame memory 106. The microprocessor 104, receiving the instruction command from the user, drives the image display terminal 100 and performs operations for decoding the compressed image data, processing signals and displaying the information. The image data to which signal processing is applied are temporarily stored in the frame memory 106.

In case that the microprocessor 104 receives an instruction command requesting an information display in “backlight display mode”, the image data are supplied from the frame memory 106 into the reflection/transmission display poly-Si TFT liquid crystal display panel 110 through the display panel controller 105 in responsive to the instruction command from the microprocessor 104, and then the pixel matrix 111 display the image data supplied in the above manner in real time. In accordance with this operation, the display panel controller 105 outputs a designated timing pulse required to display the image synchronously. As described in the embodiment 1, the reflection/transmission display poly-Si TFT liquid crystal display panel 110 uses those signals and display 64 gray-scaled multi-valued data generated from 6-bit image data on the pixel matrix 111 in real time. It is allowed that the I/O circuit 102 drives the pixel matrix backlight 108 and the pixel display terminal 100 provides a high-quality display image including motion pictures. The electric power source 107 includes a secondary battery, which supplies electric power for driving the overall image display terminal 100.

Next, in case that the microprocessor 104 receives an instruction command requesting an information display in “reflection display model, after the designated image data are supplied from the frame memory 106 into the reflection/transmission display poly-Si TFT liquid crystal display panel 110 through the display panel controller 105 in responsive to the instruction command from the microprocessor 104, then the designated components including the frame memory 106 and the pixel matrix backlight 108 are turned off, and the microprocessor 104 is operated in low electric power consumption mode in order to reduce the electric power consumption in the image display terminal 100. As described in the embodiment 1, the reflection/transmission display poly-Si TFT liquid crystal display panel 110 uses 3-bit image data written in the individual pixels and performs display operation with low electric power consumption without using the signal line 12. In this case of “reflection display mode”, as the data length for the display image is 3-bit and thus smaller in comparison with the “backlight display mode” with 6-bit 64 gray-scaled multi-valued data display, a designated amount in the data is reduced by the instruction from the microprocessor 104 in the image data transmission to the reflection/transmission display poly-Si TFT liquid crystal display panel 110. The 3-bit image data displayed by the reflection/transmission display poly-Si TFT liquid crystal display panel 110 can be rewritten arbitrarily by the instruction from the microprocessor 104.

According to this embodiment, it will be appreciated that the image display terminal 100 can be provided in which high-quality image display in “backlight display mode”, and low electric power consumption image display in “reflection display mode” can be provided selectively.

Though this embodiment uses the reflection/transmission display poly-Si TFT liquid crystal display panel 110 described in the embodiment 1 for providing image display, and the pixel matrix backlight 108 is selectively turned on and off for either “backlight display mode” or “reflection display mode”, it is allowed to use various display panels described in other embodiments in the present invention. Such display panels are not limited to a display panel allowing reflection display operation and transmission display operation selectively. Even in case of the display panel only using reflection display operation, such an image display terminal as described above can be realized similarly, and even in case of the display panel using luminescence devices, a display operation mode for high quality image display with higher electric power consumption and a display mode for image display with lower electric power consumption can be selected exclusively in a single apparatus with “high contrast mode and low contrast mode”. Though display operations for providing multi-valued data image and 3-bit image data stored in the individual pixel are automatically switched in responsive to the selection of “backlight display mode” and “reflection display mode” in this embodiment, it is allowed to select those display modes arbitrarily based on another condition. For example, those display modes may be allowed to be switched for displaying motion pictures or still images, or multi-valued data image display is not employed but image data stored temporarily in the individual pixel are always used in stead. Alternatively, it is allowed to modify the bit length of the display image data arbitrarily in those cases.

According to the present invention, the reduction of the electric power consumption and the downsizing of the cost in the image display apparatus can be established simultaneously. In addition, multi-bit image data can be displayed.

Whata is claimed is:

1. An image display apparatus comprising
a display part composed of plural pixels;
a control part for controlling said display part; and
a signal line arranged inside said display part for inputting a display signal into said pixel,
wherein
said pixel has at least one or more switches and first capacitances for storing said display signal input through said signal line as charge for a designated period of time or longer; and
further comprising a means for rewriting said display signal stored in said first capacitance into said first capacitance without using said signal line in responsive to an instruction of said control part.

2. An image display apparatus of claim 1, wherein
a data length of said display signal stored in said pixel as charge is 1-bit.

3. An image display apparatus of claim 1, wherein
one terminal of said first capacitance is connected to a gate of first field effect transistor formed inside said pixel.

4. An image display apparatus of claim 3, wherein
a drain of said first field effect transistor is connected to ground.

5. An image display apparatus of claim 3, wherein
one terminal of said first capacitance is connected to a gate of second field effect transistor formed inside said pixel; and
one terminal of said second field effect transistor is connected to a capacitance composed of liquid crystal.

6. An image display apparatus of claim 1, wherein
said first capacitance includes a capacitance composed of liquid crystal.

7. An image display apparatus of claim 6, wherein
said pixel has a means for making said display signal rewritten in said first capacitance take two voltage values alternately for every rewrite operation.

8. An image display apparatus of claim 7, wherein
said first capacitance is connected through a first switch formed inside said pixel to an output of an inverter circuit formed inside said pixel.

9. An image display apparatus of claim 7, wherein
said first capacitance is connected through a second switch formed inside said pixel to an input of an inverter circuit formed inside said pixel.

10. An image display apparatus of claim 8 or 9, wherein
said inverter circuit is configured as CMOS (Complementary Metal Oxide Semiconductor) circuit.

11. An image display apparatus of claim 1, wherein
said individual pixel has (n+1) or more plural capacitances for storing an n-bit display signal as charge for a designated period of time.

12. An image display apparatus of claim 11, wherein
said first capacitance included inside said plural capacitances includes a capacitance composed of liquid crystal.

13. An image display apparatus of claim 12, wherein
said pixel has a means for inputting sequentially an n-bit display signal as charge into said first capacitance.

14. An image display apparatus of claim 13, wherein
said pixel has a means f or forming an (n+1)st n-bit display signal input sequentially as charge into said first capacitance to be an inverted signal of first display signal.

15. An image display apparatus of claim 11, wherein
said pixel has plural amplifier circuits in the number identical to the number of said plural capacitances.

16. An image display apparatus of claim 15, wherein
said plural amplifier circuits are composed of inverter circuits.

17. An image display apparatus of claim 16, wherein
said plural inverter circuits is composed of CMOS circuits.

18. An image display apparatus of claim 1, wherein
said individual pixel has a charge transfer device (CTD).

19. An image display apparatus of claim 18, wherein
said charge transfer device is BBD (Bucket Brigade Device).

20. An image display apparatus of claim 18 or 19, wherein
said charge transfer device has plural transfer gates; and
said control part has a means for driving said individual plural transfer gates separately.

21. An image display apparatus of claim 18 or 19, wherein
said charge transfer device has plural transfer gates; and
said control part has a means for driving said individual plural transfer gates with a two-phase clock.

22. An image display apparatus of claim 20 or 21, wherein
said plural transfer gates in said individual pixel are connected to one another commonly among plural pixels.

23. An image display apparatus of claim 22, wherein
said plural transfer gates in said individual pixel are substantially connected to one another among all pixels in said display part.

24. An image display apparatus of claim 18, wherein
said first capacitance is composed of a capacitance composed of liquid crystal.

25. An image display apparatus of claim 24, wherein
said pixel has a means for inputting sequentially an n-bit display signal as charge into said first capacitance.

26. An image display apparatus of claim 25, wherein
said pixel has a means for forming an (n+1)st n-bit display signal input sequentially as charge into said first capacitance to be an inverted signal of first display signal.

27. An image display apparatus of claim 24, wherein
said first capacitance is input to said charge transfer device.

28. An image display apparatus of claim 18, wherein
an output of said charge transfer device has an amplifier circuit.

29. An image display apparatus of claim 28, wherein
said amplifier circuit is an inverter circuit.

30. An image display apparatus of claim 29, wherein
said plural inverter circuits is composed of CMOS circuits.

31. An image display apparatus of claim 1, wherein
one terminal of said first capacitance is connected to a gate of third field effect transistor with its one of current terminals connected to a luminescence device formed inside said pixel.

32. An image display apparatus of claim 31, wherein
said luminescence device is an organic light emitting diode (OLED).

33. An image display apparatus comprising
a display part composed of plural pixels;
a display signal processing part for storing a display signal supplied from outside and performing data processing for said display signal;
a control part for controlling said display part and said display signal processing part; and
a signal line arranged inside said display part for inputting a display signal into said pixel,
wherein
said pixel has at least one or more switches and first capacitances for storing said display signal input through said signal line as charge for a designated period of time; and
further comprising a means for rewriting said display signal stored ins said first capacitance into said first capacitance without using said signal line in responsive to an instruction of said control part.

34. An image display apparatus of claim 33, wherein
said pixel has a reflection-type image display means using an external light.

35. An image display apparatus of claim 34, wherein
said pixel has a reflection-type image display means and a transmission-type or reflection-type image display means using a backlight means formed inside an image display apparatus.

36. An image display apparatus of claim 1, wherein
said switch is composed of TFT (Thin-Film-Transistor).

37. An image display apparatus of claim 36, wherein
a channel film of said TFT is formed by poly-Si TFT.

38. An image display apparatus of claim 37, wherein
said pixel has a charge transfer device wherein poly-Si is used for a channel film.

39. An image display apparatus of claim 38, wherein
said charge transfer device is BBD (Bucket Brigate Device).

40. An image display apparatus of claim 39, wherein
a channel film of said TFT and a channel film of said BBD are formed in an identical process.

41. An image display apparatus of claim 39, wherein
a gate electrode of said TFT and a gate electrode of said BBD are formed in an identical process.

42. A drive method of an image display apparatus comprising
a display part composed of plural pixels;
a control part for controlling said display part; and
a signal line arranged inside said display part for inputting a display signal into said pixel; wherein
said pixel has at least one or more switches and first capacitances for storing said display signal input through said signal line as charge for a designated period of time,
wherein
said display signal stored in said first capacitance is rewritten into said first capacitance without using said signal line in responsive to an instruction of said control part.

43. A drive method of an image display apparatus of claim 42, wherein
said first capacitance includes a capacitance formed between a couple of display part common electrodes with liquid crystal;
a display signal formed by inverting a previous display signal is rewritten into said first capacitance at every rewrite operation; and
said common electrode is driven to be inverted substantially in synchronization with said rewrite operation of inverted signal.

44. A drive method of an image display apparatus of claim 42, wherein
said individual pixel has plural capacitances and one or more amplifier circuits; and
plural display signals stored in said plural capacitances are input sequentially to said amplifier circuit.

45. A drive method of an image display apparatus of claim 44, wherein
said first capacitance includes a capacitance formed between a couple of display part common electrodes with liquid crystal; and
an output of said amplifier circuit is input through switch to said first capacitance with a designated time interval.

46. A drive method of an image display apparatus of claim 45, wherein
a time interval with which said amplifier circuit inputs a display signal through said switch to said first capacitance is defined so as to increase substantially twice as long as said individual display signals.

47. A drive method of an image display apparatus of claim 45, wherein
said common electrode is also driven to be inverted substantially in synchronization with an overall cycle of said amplifier circuit writing a display signal through said switch to said first capacitance.

48. A drive method of an image display apparatus of claim 44, wherein
an individual single bit of display signal is written sequentially to individual pixels when writing plural display signals through said signal line to said plural capacitances.

49. A drive method of an image display apparatus of claim 42, wherein
writing operation for display signals having analog voltage or multi-valued voltage levels is performed by interrupting rewrite operation for said first capacitance in said pixel and using a signal line to said first capacitance in stead.

50. A drive method of an image display apparatus comprising
a display part composed of plural pixels;
a display signal processing part for storing a display signal supplied from outside and performing data processing for said display signal;
a control part for controlling said display part and said display signal processing part; and
a signal line arranged inside said display part for inputting a display signal into said pixel; wherein
said pixel has at least one or more switches and first capacitances for storing said display signal input through said signal line as charge for a designated period of time,
said method comprising
a first mode for rewriting said display signal stored in said first capacitance into said first capacitance without using said signal line in responsive to an instruction of said control part; and
a second mode for writing a display signal having analog voltage or multi-valued voltage levels is performed by interrupting said rewrite operation for said first capacitance in said pixel and using a signal line to said first capacitance in stead,
wherein
an electric power consumption of a display signal processing part in said first mode is made smaller than an electric power consumption of a display signal processing part in said second mode.
